(19) United States
(12) Patent Application Publication
(10) Pub. No.: US 2025/0344292 A1
(43) Pub. Date: Nov. 6, 2025

(54) HEATER ELEMENT

(71) Applicant: NGK INSULATORS, LTD., Nagoya-City (JP)

(72) Inventors: Toshiki IWATSUKI, Nagoya-Shi (JP); Yoshiki KONNO, Nagoya-Shi (JP); Narimasa SHINODA, Nagoya-Shi (JP); Takahiko NAKATANI, Nagoya-Shi (JP); Yukio MIYAIRI, Nagoya-Shi (JP)

(73) Assignee: NGK INSULATORS, LTD., Nagoya-City (JP)

(21) Appl. No.: 19/268,016

(22) Filed: Jul. 14, 2025

Related U.S. Application Data
(63) Continuation of application No. PCT/JP2024/011774, filed on Mar. 25, 2024.

(30) Foreign Application Priority Data
Mar. 30, 2023 (JP) 2023-056758

(51) Int. Cl. H05B 3/03; H05B 3/16

(52) U.S. Cl. CPC H05B 3/03; H05B 3/16; H05B 2203/02

(57) ABSTRACT

A heater element includes: a honeycomb structure portion capable of generating heat by energization, including an outer peripheral wall, and partition walls disposed on an inner peripheral side of the outer peripheral wall, the partition walls partitioning a plurality of cells that form flow paths extending from a first end surface to a second end surface, and the partition walls including a material having a PTC characteristic; a first electrode layer covering a part or all of a surface of the partition walls forming the first end surface; a second electrode layer covering a part or all of a surface of the partition walls forming the second end surface; a first moisture absorbent-containing layer covering a part of an outer surface of the first electrode layer; and a second moisture absorbent-containing layer covering a part of an outer surface of the second electrode layer.

### CROSS REFERENCE TO RELATED APPLICATIONS

The present invention claims the benefit of priority to Japanese Patent Application 2023-056758 filed on Mar. 30, 2023 with the Japanese Patent Office, the entire contents of which are incorporated herein by reference in its entirety.

### FIELD OF THE INVENTION

The present invention is related to a heating element.

### BACKGROUND OF THE INVENTION

There is an increasing demand for improved interior environments in automobiles and other vehicles. Specific demands include reducing CO₂ inside the interior to suppress driver drowsiness, controlling humidity inside the interior, and removing odorous components, allergy-inducing components, and other harmful volatile components from the interior. One effective measure to meet such demands is ventilation, but ventilation causes a large loss of heater energy in winter, leading to a deterioration in energy efficiency in winter. In particular, in electric vehicles (BEVs: Battery Electric Vehicles), this energy loss causes a significant reduction in the driving range.

Accordingly, Patent Literature 1 and 2 disclose a vehicle interior purification system in which components to be removed, such as water vapor and CO₂, in the air inside the vehicle interior are captured in a functional material such as an adsorbent, and then the components to be removed are reacted or desorbed by heating and released outside the vehicle, thereby regenerating the functional material. In such vehicle interior purification systems, it is required that there is as much contact between the air and the functional material as possible to ensure the capture performance of the components to be removed, and that the functional material be capable of being heated to a predetermined temperature to promote regeneration of the functional material. Regeneration can be carried out, for example, by a method of removing substances adsorbed onto the functional material through an oxidation reaction, or by a method of desorbing and discharging the substances adsorbed onto the functional material. In either case, it is necessary to heat the functional material to an appropriate temperature depending on the substance to be adsorbed.

As a heating means, a vapor compression heat pump is superior in terms of thermal efficiency, but there are problems with the vapor compression heat pump, such as the difficulty in operating when the outside air is extremely low, and the difficulty in rapidly heating the interior when the vehicle is started. Therefore, it is considered practical to use a vapor compression heat pump as the main heating device and to use a heater element that utilizes Joule heat as an auxiliary device when rapid heating is required at the start of the vehicle or when the outside temperature is very low.

However, a heater element that utilizes Joule heat tends to be large in size, which poses a problem of taking up space inside the vehicle. It would therefore be desirable to provide a more compact heater element. In this regard, it is known that a heater element having a honeycomb structure portion with PTC characteristics is advantageous because it can increase the heat transfer area per unit volume and prevent excessive heat generation (Patent Literature 3).

On the other hand, it has also been pointed out that the electrical circuits of heater elements having a honeycomb structure portion may be short-circuited by condensation water. To address this problem, Patent Literature 4 proposes covering at least a portion of the honeycomb structure portion with a dense insulating film. Specifically, it describes a heater element for heating an interior of a vehicle, the heater element comprising a pillar-shaped honeycomb structure portion having an outer peripheral wall and partition walls disposed on the inner peripheral side of the outer peripheral wall and defining a plurality of cells that form flow paths from a first end surface to a second end surface, wherein the outer peripheral wall and the partition walls are made of a material having a PTC characteristic, and heater element further comprises a dense insulating film that covers at least a part of the pillar-shaped honeycomb structure portion.

Patent Literature 4 also discloses that a conductive member connectable to an external power source is disposed on at least a portion of an electrode layer, that a conductive member and the electrode layer are electrically connected, and that at least a portion of the electrode layer and the conductive member are covered by the insulating film. Furthermore, Patent Literature 4 describes, as the insulating material, resins (polyimide resins, polyamide resins, polyamideimide resins, fluororesins, phenolic resins, silicone resins, epoxy resins, furan resins, polyvinylidene fluoride, polyphenylene sulfide, polyetherimide, polysulfone, polyamideimide, and the like), glass, and ceramics. As the ceramics, alumina, mullite, and spinel are described. Patent Literature 4 also discloses that at least a part of the electrode layer and the conductive member is covered with an insulating film.

### PRIOR ART

### Patent Literature

[Patent Literature 1] Japanese Patent Application Publication No. 2020-10477
[Patent Literature 2] Japanese Patent Application Publication No. 2020-111282
[Patent Literature 3] WO 2020/036067 A1
[Patent Literature 4] WO 2021/166293 A1

### SUMMARY OF THE INVENTION

Patent Literature 4 discloses that short circuits are prevented by covering at least a portion of the honeycomb structure portion with a dense insulating film, but does not discuss the necessity of the moisture absorption function. If the condensed condensation water remains in the form of droplets in the honeycomb structure portion, the flow paths within the cells will be narrowed, causing increase in the ventilation resistance of the gas flowing through the honeycomb structure portion, and the condensation water will splash to other locations inside or outside the heater, and may cause problems such as electrical short circuits at the splash location, or the water droplets may reach the interior and splash on the occupants. Therefore, it is desirable not only to prevent short circuits in the honeycomb heater itself, but also to take prompt action to prevent condensation water adhering to the honeycomb structure portion from causing problems in downstream components or to the vehicle interior environment as described above.

The present invention has been made in consideration of the above circumstances, and an object in one embodiment is to provide a heater element that can suppress short circuits and that is less likely to cause condensation water to remain in the form of droplets.

The present inventors have conducted extensive research to solve the above problems and have found that it is advantageous to cover the outer surface of the electrode layer covering the end surfaces of the honeycomb structure portion with a moisture absorbent-containing layer. The present invention has been completed based on this finding, and is exemplified as follows.

[1]

A heater element, comprising:
a honeycomb structure portion capable of generating heat by energization, comprising an outer peripheral wall, and partition walls disposed on an inner peripheral side of the outer peripheral wall, the partition walls partitioning a plurality of cells that form flow paths extending from a first end surface to a second end surface, and the partition walls comprising a material having a PTC characteristic;
a first electrode layer covering a part or all of a surface of the partition walls forming the first end surface;
a second electrode layer covering a part or all of a surface of the partition walls forming the second end surface;
a first moisture absorbent-containing layer covering a part of an outer surface of the first electrode layer; and
a second moisture absorbent-containing layer covering a part of an outer surface of the second electrode layer.
   [2]

The heater element according to [1], wherein an average thickness of at least one of the first moisture absorbent-containing layer and the second moisture absorbent-containing layer is 10 μm or more and 500 μm or less.

[3]

The heater element according to [1] or [2], wherein a maximum water absorption (g) of the heater element per unit volume (1 liter) of the honeycomb structure portion is 20 to 400 g/liter.

[4]

The heater element according to any one of [1] to [3], wherein the first moisture absorbent-containing layer and the second moisture absorbent-containing layer are insulating.

[5]

The heater element according to any one of [1] to [4], wherein the first moisture absorbent-containing layer and the second moisture absorbent-containing layer comprise an inorganic binder.

[6]

The heater element according to any one of [1] to [5], wherein the first moisture absorbent-containing layer and the second moisture absorbent-containing layer comprise, in addition to the moisture absorbent, a functional material having a function of adsorbing carbon dioxide and/or an organic gas component.

[7]

The heater element according to any one of [1] to [6],
wherein assuming a region having a length of 0.5 cm from the outer surface of the first moisture absorbent-containing layer toward the second end surface in a direction in which the cells extend is a first region, a maximum water absorption amount per unit volume (1 liter) of the first region is 90 to 200 g/liter; and
wherein assuming a region having a length of 0.5 cm from the outer surface of the second moisture absorbent-containing layer toward the first end surface in a direction in which the cells extend is a second region, a maximum water absorption amount per unit volume (1 liter) of the second region is 90 to 200 g/liter.
   [8]

The heater element according to any one of [1] to [7], wherein an average thickness of the first electrode layer and the average thickness of the second electrode layer are 5 μm or more and 100 μm or less, respectively.

[9]

The heater element according to any one of [1] to [8],
wherein the first moisture absorbent-containing layer covers 80% or more of an area among a portion of the outer surface of the first electrode layer to which a first terminal is not connected; and
wherein the second moisture absorbent-containing layer covers 80% or more of an area among a portion of the outer surface of the second electrode layer to which a second terminal is not connected.
   [10]

The heater element according to any one of [1] to [9], further comprising:
a first terminal connected to a portion of the outer surface of the first electrode layer that is not covered by the first moisture absorbent-containing layer;
a second terminal connected to a portion of the outer surface of the second electrode layer that is not covered by the second moisture absorbent-containing layer;
a third moisture absorbent-containing layer that covers a portion of an outer surface of the first terminal; and
a fourth moisture absorbent-containing layer that covers a portion of an outer surface of the second terminal.
   [11]

The heating element according to [10], wherein the third moisture absorbent-containing layer and the fourth moisture absorbent-containing layer are insulating.

[12]

The heater element according to [10] or [11], wherein the third moisture absorbent-containing layer and the fourth moisture absorbent-containing layer comprise an inorganic binder.

[13]

The heater element according to any one of [10] to [12], wherein the third moisture absorbent-containing layer and the fourth moisture absorbent-containing layer comprise, in addition to the moisture absorbent, a functional material having a function of adsorbing carbon dioxide and/or an organic gas component.

[14]

The heater element according to any one of [1] to [13], wherein the first electrode layer and the second electrode layer comprise one or more selected from a group consisting of pure aluminum, an aluminum alloy, and stainless steel.

[15]

The heater element according to [14], wherein the first electrode layer and the second electrode layer have a single layer of pure aluminum, a two-layer structure of an Al—Ni alloy layer and a pure silver layer, or a two-layer structure of an Al—Ni alloy layer and a pure aluminum layer.

[16]

The heater element according to any one of [10] to [15], wherein
the first terminal and the second terminal comprise one or more selected from pure aluminum, an aluminum alloy, and stainless steel;
the first terminal is connected to the portion of the outer surface of the first electrode layer that is not covered by the first moisture absorbent-containing layer by welding, brazing, or mechanical contact; and
the second terminal is connected to the portion of the outer surface of the second electrode layer that is not covered by the second moisture absorbent-containing layer by welding, brazing, or mechanical contact.
   [17]

The heater element according to any one of [1] to [16], further comprising a fifth moisture absorbent-containing layer covering a part or all of a surface of the partition walls forming the flow paths inside the cells.

According to one embodiment of the present invention, it is possible to provide a heater element that can suppress short circuits and that is less likely to cause condensation water to remain in the form of droplets. In addition, by providing a functional material-containing layer having the function of adsorbing components to be removed in the air, such as water vapor, carbon dioxide, and odorous components, on the surface of the partition walls that form the flow paths inside the cells of the heater element, it is also possible to contribute to improving the vehicle interior environment. This heater element is useful for improving the environment not only in the vehicle interior but in any indoor space.

### BRIEF DESCRIPTION OF THE DRAWINGS

FIG. 1A is a schematic diagram of a heater element according to one embodiment of the present invention, as viewed from the side of the first end surface.

FIG. 1B is a schematic cross-sectional view taken along the X-X line of FIG. 1A.

FIG. 1C is a schematic cross-sectional view of a heater element according to another embodiment of the present invention, as viewed from the side of the first end surface.

FIG. 1D is a schematic cross-sectional view taken along the X-X line of FIG. 1C.

FIG. 2A is a schematic diagram of an example of a heater element assembly comprising a frame that clamps a heater element from the first end surface side and the second end surface side, as viewed from the side of the first end surface.

FIG. 2B is a schematic cross-sectional view taken along the X-X line of FIG. 2A.

FIG. 3A is a schematic diagram of another example of a heater element assembly comprising a frame that clamps a heater element from the first end surface side and the second end surface side, as viewed from the side of the first end surface.

FIG. 3B is a schematic cross-sectional view taken along the X-X line of FIG. 3A.

FIG. 4A is a schematic diagram of an example of a heater element assembly having a frame that holds a heater element from the outer peripheral surface side of the outer peripheral wall, as viewed from the side of the first end surface.

FIG. 4B is a schematic cross-sectional view taken along the line X-X of FIG. 4A.

FIG. 4C is a schematic view showing a pair of half-split members sandwiching a heater element and approaching each other from a direction perpendicular to the direction in which the flow paths of a honeycomb structure portion extend.

FIG. 5A is a schematic diagram of another example of a heater element assembly having a frame that holds a heater element from the outer peripheral surface side of the outer peripheral wall, as viewed from the side of the first end surface.

FIG. 5B is a schematic cross-sectional view taken along the line X-X of FIG. 5A.

FIG. 5C is a schematic diagram of yet another example of a heater element assembly having a frame that holds a heater element from the outer peripheral surface side of the outer peripheral wall, as viewed from the side of the first end surface.

FIG. 6 is a schematic diagram showing an example of the configuration of an air conditioning system according to one embodiment of the present invention.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

### (1. Heater Element)

The heater element according to embodiments of the present invention can be suitably used to improve the indoor environment in various vehicles such as automobiles. Examples of the vehicle include, but are not limited to, automobiles and trains. Examples of the automobile include, but are not limited to, gasoline vehicles, diesel vehicles, gas-fueled vehicles using CNG (compressed natural gas) or LNG (liquefied natural gas), fuel cell vehicles, electric vehicles, and plug-in hybrid vehicles. The heater element according to embodiments of the present invention can be suitably used in vehicles that do not have an internal combustion engine, such as electric vehicles and trains.

In addition, the heater element according to the embodiments of the present invention can be used to improve the interior space of buildings such as houses, offices, factories, stores, and warehouses, as well as vehicles such as ships and airplanes, other than vehicles.

The heater element according to embodiments of the present invention can be used for heating purposes, and can also be equipped with the function of removing components to be removed from the air, thereby contributing to improving the indoor environment. For example, the function can be added by providing a functional material-containing layer having the function of adsorbing components to be removed in the air, such as water vapor, carbon dioxide, and odorous components, on the surface of the partition walls that form the flow paths inside the cells of the heater element. A moisture absorbent-containing layer, which is a type of functional material-containing layer, may be provided on the surface of the partition walls that form the flow paths inside the cells of the heater element.

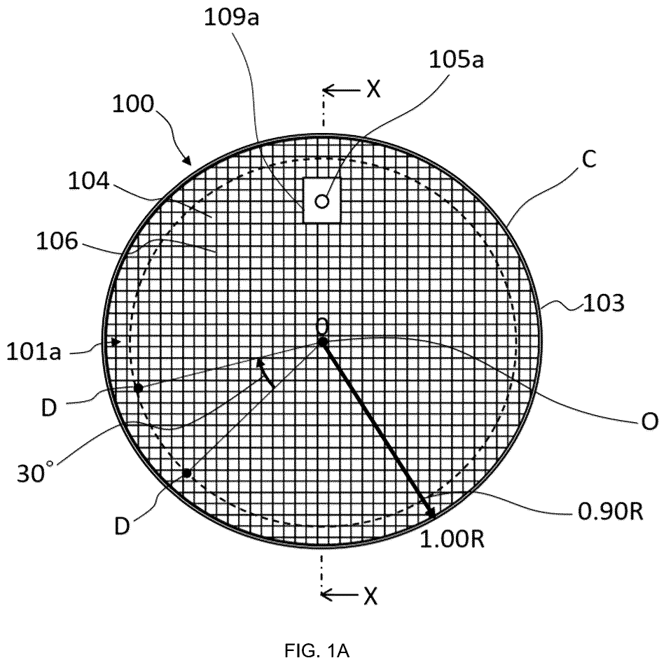

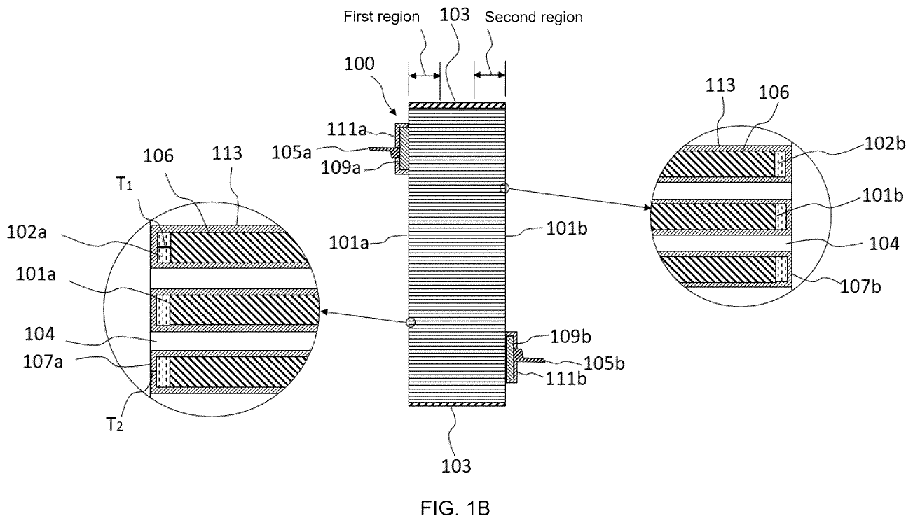

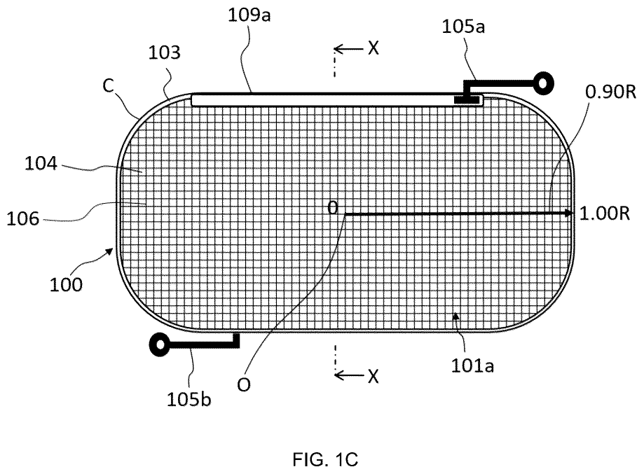

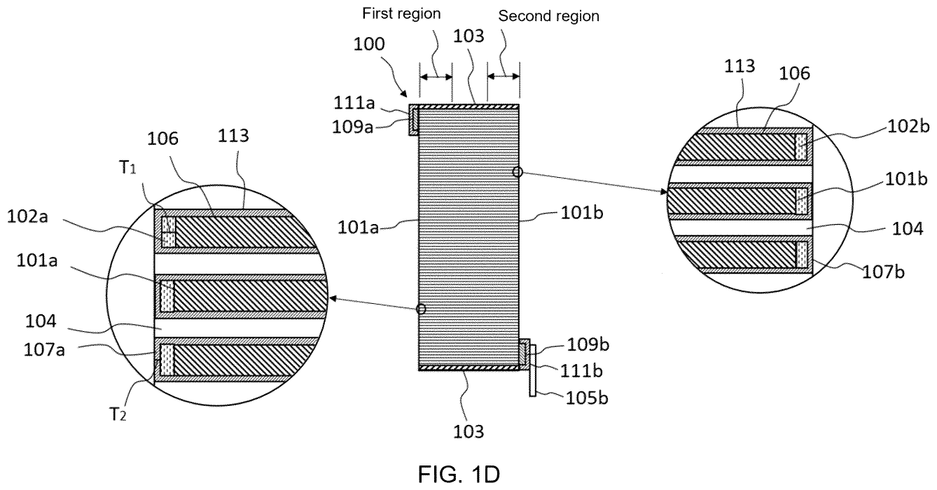

FIG. 1A shows a schematic diagram of a heater element 100 according to one embodiment of the present invention as viewed from the side of the first end surface. FIG. 1B shows a schematic cross-sectional view taken along the line X-X of FIG. 1A. FIG. 1C is a schematic diagram of a heater element 100 according to another embodiment of the present invention as viewed from the side of the first end surface. FIG. 1D is a schematic cross-sectional view taken along the line X-X of FIG. 1C.

The heater element 100 comprises a honeycomb structure portion having an outer peripheral wall 103; and partition walls 106 disposed on the inner peripheral side of the outer peripheral wall 103 and partitioning a plurality of cells 104 that form flow paths extending from a first end surface 101a to a second end surface 101b.

The heater element 100 comprises a first electrode layer 102a covering a part or all of the surface of the partition walls 106 that form the first end surface 101a, and a second electrode layer 102b covering a part or all of the surface of the partition walls 106 that form the second end surface 101b.

The heater element 100 comprises a first moisture absorbent-containing layer 107a covering a portion of the outer surface of the first electrode layer 102a (thereby indirectly covering the first end surface 101a), and a second moisture absorbent-containing layer 107b covering a portion of the outer surface of the second electrode layer 102b (thereby indirectly covering the second end surface 101b).

The heater element 100 comprises a first terminal 109a connected to a portion of the outer surface of the first electrode layer 102a that is not covered by the first moisture absorbent-containing layer 107a, and a second terminal 109b connected to a portion of the outer surface of the second electrode layer 102b that is not covered by the second moisture absorbent-containing layer 107b.

The heater element 100 comprises a third moisture absorbent-containing layer 111a that covers a portion of the outer surface of the first terminal 109a, and a fourth moisture absorbent-containing layer 111b that covers a portion of the outer surface of the second terminal 109b.

The heater element 100 comprises a fifth moisture absorbent-containing layer 113 that covers a part or all of the surface of the partition walls 106 that form the flow paths inside the cell 104.

The configuration of the heater element 100 will be described in detail as below.

### (1-1. Honeycomb Structure Portion)

The shape of the honeycomb structure portion is not particularly limited. For example, the outer shape of the cross-section orthogonal to the direction in which the flow paths of the honeycomb structure portion extend (the direction in which the cells 104 extend) can be polygons (quadrangles (rectangles, squares), pentagons, hexagons, heptagons, octagons, and the like), round shapes (circle shapes, ellipse shapes, oval shapes, ovate shapes, oblong shapes, rounded quadrangles (a quadrangle whose sides and corners are curved, and the radius of curvature of each side is larger than the radius of curvature of each corner, and whose entire shape is composed of curves) and the like) and the like. Further, when the outer shape of the cross-section is a polygon, the corners may be chamfered. In order to prevent damage to the honeycomb structure portion and to make it easier to wrap the cushioning material around the outer peripheral surface, it is particularly preferable that the corners have an R-chamfered shape, and it is more preferable that the corners do not have a radius of curvature of 5 mm or less, and it is even more preferable that the radius of curvature of the corners is 10 mm or more, even more preferably 20 mm or more. Although the upper limit of the radius of curvature of the corners is not limited, it can be 40 mm or less, and is typically 30 mm or less. In addition, the end surfaces (first end surface 101a and second end surface 101b) have the same shape as the cross-section. In the heater element 100 shown in FIGS. 1A and 1B, the cross-section of the honeycomb structure portion has a circular outer shape, and the honeycomb structure portion has a cylindrical outer shape as a whole. In the heater element 100 shown in FIGS. 1C and 1D, the outer shape of the cross-section of the honeycomb structure portion is a rectangle with an R chamfer, and the outer shape of the honeycomb structure portion as a whole is a quadrangular prism shape with an R chamfer.

The opening shape of the cells 104 is not particularly limited and in the cross-section orthogonal to the direction in which the flow paths of the honeycomb structure portion extend, it can be polygons (quadrangles (rectangles, squares), pentagons, hexagons, heptagons, octagons, and the like), round shapes (circle shapes, ellipse shapes, oval shapes, ovate shapes, oblong shapes and the like) and the like. These shapes may be single or a combination of two or more shapes. Further, among these shapes, a quadrangle or a hexagon is preferable. By providing cells 104 having such a shape, pressure loss when air flows can be reduced. When the opening shape of the cells 104 is polygonal, the corners may be rounded. In addition, in the illustrated heater element 100, the opening shape of the cells 104 is square.

The honeycomb structure portion may be a honeycomb joined body having a plurality of honeycomb segments and joining layers that joins the outer peripheral surfaces of the plurality of honeycomb segments. By using a honeycomb joined body, it is possible to increase the total cross-sectional area of the cells 104, which is important for ensuring the flow rate of air, while suppressing the occurrence of cracks. The joining layers can be formed using a joining material. The joining material is not particularly limited, but a paste made by adding a solvent such as water to a ceramic material can be used. The joining material may contain a material having PTC characteristics, or may contain the same material as the outer peripheral wall 103 and the partition walls 106. In addition to the role of joining honeycomb segments, the joining material can also be used as an outer peripheral coating material after joining the honeycomb segments.

From the view point of ensuring the strength of the honeycomb structure portion, reducing pressure loss when air passes through the cells 104, ensuring the carried amount of functional material such as moisture absorbent, and ensuring the contact area with the air flowing inside the cells 104, electrical resistance between end surfaces, and the like, it is desirable to appropriately coordinate the thickness of the partition walls 106, cell density, and cell pitch (or opening ratio of cell).

As used herein, the thickness of the partition walls 106 refers to a crossing length of a line segment that crosses the partition wall 106 when the centers of gravity of adjacent cells 104 are connected by this line segment in a cross-section orthogonal to the direction in which the flow paths extend.

As used herein, the cell density refers to a value obtained by dividing the number of cells by the area of one end surface of the honeycomb structure portion (the total area of the partition walls 106 and the cells 104 excluding the outer peripheral wall 103).

As used herein, the cell pitch refers to a value determined by the following calculation. First, the area per cell is calculated by dividing the area of one end surface of the honeycomb structure portion (the total area of the partition walls 106 excluding the outer peripheral wall 103 and the cells 104) by the number of cells. Next, the square root of the area per cell is calculated, and this is taken as the cell pitch.

As used herein, the opening ratio of the cell 104 is a value obtained by dividing the total area of the cells 104 partitioned by the partition walls 106 by the area of one end surface (the total area of the partition walls 106 and the cells 104 excluding the outer peripheral wall 103), in the cross-section orthogonal to the direction in which the flow paths of the honeycomb structure portion extend. In addition, when calculating the opening ratio of the cells 104, layers provided on the partition walls 106, such as an electrode layer, a moisture absorbent-containing layer, and a functional material-containing layer, are not taken into account.

In an embodiment that is advantageous from the viewpoint of carrying a sufficient amount of functional material, the thickness of the partition walls is 0.180 mm or less, the cell density is 100 cells/cm² or less, and the cell pitch is 1.0 mm or more. In a preferred embodiment, the thickness of the partition walls is 0.130 mm or less, the cell density is 70 cells/cm² or less, and the cell pitch is 1.2 mm or more. In a more preferred embodiment, the thickness of the partition walls is 0.100 mm or less, the cell density is 65 cells/cm² or less, and the cell pitch is 1.3 mm or more.

In each of the above embodiments, from the viewpoint of ensuring the strength of the honeycomb structure portion and keeping the electrical resistance low, the lower limit of the thickness of the partition walls is preferably 0.010 mm or more, more preferably 0.020 mm or more, and even more preferably 0.030 mm or more.

In each of the above embodiments, from the viewpoint of ensuring the strength of the honeycomb structure portion, keeping the electrical resistance low, and increasing the surface area to promote reaction, adsorption and desorption by the functional material, the lower limit of the cell density is preferably 30 cells/cm² or more, more preferably 35 cells/cm² or more, and even more preferably 40 cells/cm² or more.

In each of the above embodiments, from the viewpoint of ensuring the strength of the honeycomb structure portion, keeping the electrical resistance low, and increasing the surface area to promote reaction, adsorption, and desorption by the functional material, the upper limit of the cell pitch is preferably 2.0 mm or less, more preferably 1.8 mm or less, and even more preferably 1.6 mm or less.

In an embodiment that is advantageous from the viewpoint of both reducing pressure loss and maintaining strength, the thickness of the partition walls is 0.08 mm or more and 0.36 mm or less, and the cell density is 2.54 cells/cm² or more and 140 cells/cm² or less, and the opening ratio of the cells is 0.70 or more. In a preferred embodiment, the thickness of the partition walls is 0.09 mm or more and 0.35 mm or less, the cell density is 15 cells/cm² or more and 100 cells/cm² or less, and the opening ratio of the cells is 0.75 or more. In a more preferred embodiment, the thickness of the partition walls is 0.10 mm or more and 0.30 mm or less, the cell density is 20 cells/cm² or more and 90 cells/cm² or less, and the cell opening ratio is 0.77 or more.

In each of the above embodiments, from the viewpoint of ensuring the strength of the honeycomb structure portion, the upper limit of the opening ratio of the cells is preferably 0.94 or less, more preferably 0.92 or less, and even more preferably 0.90 or less.

The thickness of the outer peripheral walls 103 is not particularly limited, but is preferably determined based on the following viewpoint. First, from the viewpoint of reinforcing the honeycomb structure portion, the thickness of the outer peripheral wall 103 is preferably 0.05 mm or more, more preferably 0.06 mm or more, and even more preferably 0.08 mm or more. On the other hand, from the viewpoint of suppressing the initial current by increasing electrical resistance, and from the viewpoint of reducing pressure loss when air flows, the thickness of the outer peripheral wall 103 is preferably 1.0 mm or less, more preferably 0.5 mm or less, even more preferably 0.4 mm or less, and even more preferably 0.3 mm or less.

As used herein, the thickness of the outer peripheral wall 103 refers to a length in the normal direction of the outer peripheral surface from the boundary between the outer peripheral wall 103 and the outermost cell 104 or partition wall 106 to the outer peripheral surface of the honeycomb structure portion, in a cross-section orthogonal to the direction in which the flow paths extend.

The length of the honeycomb structure portion in the direction in which the flow paths extend, and the cross-sectional area orthogonal to the direction in which the flow paths extend may be adjusted according to the required size of the heater element, and are not particularly limited. For example, when used in a compact heater element while ensuring a predetermined function, the length of the honeycomb structure portion in the direction in which the flow paths extend may be 2 to 50 mm, typically 5 to 50 mm, and the cross-sectional area orthogonal to the direction in which the flow paths extend can be 30 to 400 cm², typically 50 to 150 cm².

The partition walls 106 forming the honeycomb structure portion are made of a material that can generate heat when energized. Specifically, they are made of a material having PTC (Positive Temperature Coefficient) characteristics. If necessary, the outer peripheral wall 103 may also be made of a material having PTC characteristics like the partition walls 106.

When a functional material-containing layer such as a moisture absorbent-containing layer is provided on the partition walls 106, the functional material-containing layer can be heated by heat transfer from the heat-generated partition walls 106 (and the outer peripheral wall 103 if necessary). In addition, a material having PTC characteristics has a characteristic that when the temperature rises and exceeds the Curie point, the resistance value rapidly increases and it becomes difficult for electricity to flow. Therefore, when the heater element 100 reaches a high temperature, the current flowing through the partition walls 106 (and the outer peripheral wall 103 as necessary) is restricted, so that excessive heat generation of the heater element 100 is suppressed. Therefore, it is also possible to suppress thermal deterioration of the functional material-containing layer caused by excessive heat generation.

From the viewpoint of obtaining appropriate heat generation, the lower limit of the volume resistivity at 25° C. of the material having PTC characteristics is preferably 0.5 Ω·cm or more, more preferably 1 Ω·cm or more, even more preferably 5 Ω·cm or more, and even more preferably 10 Ω·cm or more. From the viewpoint of generating heat with a low driving voltage, the upper limit of the volume resistivity at 25° C. of the material having PTC characteristics is preferably 30 Ω·cm or less, preferably 20 Ω·cm or less, more preferably 18 Ω·cm or less, and even more preferably 16 Ω·cm or less. Therefore, the range of volume resistivity at 25° C. of a material having PTC characteristics can be, for example, 10 Ω·cm to 30 Ω·cm. As used herein, the volume resistivity at 25° C. of a material having PTC characteristics is measured according to JIS K6271: 2008.

From the viewpoint of being able to conduct electricity and generating heat, as well as having PTC characteristics, the outer peripheral wall 103 and the partition walls 106 are preferably made of a material containing barium titanate (BaTiO₃) as a main component, and more preferably a ceramic made of a material whose main component is barium titanate (BaTiO₃) based crystal grains in which a part of Ba is replaced with a rare earth element. In addition, as used herein, the term “main component” refers to a component that comprise more than 50% by mass of the entire components. The content of BaTiO₃-based crystal particles can be determined by fluorescent X-ray analysis. Other crystal particles can also be measured in the same manner as this method.

The compositional formula of BaTiO₃-based crystal particles in which a part of Ba is replaced with a rare earth element can be expressed as (Ba₁₋ₓAₓ)TiO₃. In the compositional formula, A represents one or more rare earth elements, and 0.0001≤x≤0.010.

A is not particularly limited as long as it is a rare earth element, but is preferably one or more selected from the group consisting of La, Ce, Pr, Nd, Eu, Gd, Dy, Ho, Er, Y, and Yb, and is more preferably is La. From the viewpoint of suppressing electrical resistance from becoming too high at room temperature, x is preferably 0.001 or more, more preferably 0.0015 or more. On the other hand, from the viewpoint of preventing the electrical resistance from becoming too high at room temperature due to insufficient sintering, x is preferably 0.009 or less.

The content of BaTiO₃-based crystal particles in which a part of Ba is replaced with a rare earth element in the ceramic is not particularly limited as long as it becomes the main component, but preferably it is 90% by mass or more, more preferably 92% by mass or more, and even more preferably 94% by mass or more. In addition, the upper limit of the content of BaTiO₃-based crystal particles is not particularly limited, but is generally 99% by mass or less, preferably 98% by mass or less.

From the viewpoint of reducing environmental load, it is desirable that the materials used for the outer peripheral wall 103 and the partition walls 106 substantially do not contain lead (Pb). Specifically, the outer peripheral wall 103 and the partition walls 106 have a Pb content of preferably 0.01% by mass or less, more preferably 0.001% by mass or less, and even more preferably 0% by mass. Due to the low Pb content, for example, air heated by contact with the partition walls 106 that is generating heat can be safely applied to living things such as humans. In addition, in the outer peripheral wall 103 and the partition walls 106, the Pb content is preferably less than 0.03% by mass, more preferably less than 0.01% by mass, and even more preferably 0% by mass when calculated in terms of PbO. The content of lead can be determined by ICP-MS (inductively coupled plasma mass spectrometry).

The lower limit of the Curie point of the material constituting the outer peripheral wall 103 and the partition walls 106 is preferably 100° C. or higher, more preferably 110° C. or higher, and even more preferably 125° C. or higher, from the viewpoint of efficiently heating air. Further, regarding the upper limit of the Curie point, from the viewpoint of safety for parts placed in the interior, especially in or near a vehicle interior, it is preferably 250° C. or lower, more preferably 225° C. or lower, even more preferably 200° C. or lower, even more preferably 150° C. or lower, and even more preferably 130° C. or lower. Therefore, the range of the Curie point of the material constituting the outer peripheral wall 103 and the partition walls 106 can be, for example, 100° C. or higher and 130° C. or lower.

The Curie point of the material constituting the outer peripheral wall 103 and the partition walls 106 can be adjusted by the type and added amount of shifter. For example, the Curie point of barium titanate (BaTiO₃) is approximately 120° C., but by replacing a portion of Ba and Ti with one or more of Sr, Sn, and Zr, the Curie point can be shifted to the lower temperature side.

As used herein, the Curie point is measured by the following method. A sample is attached to a sample holder for measurement, and charged in a measurement tank (for example, MINI-SUBZERO MC-810P manufactured by ESPEC Corp.). The change in electrical resistance of the sample with respect to temperature change when the temperature is increased from 10° C. is measured using a DC resistance meter (for example, multimeter 3478A manufactured by YOKOGAWA HEWLETT PACKARD, LTD.). According to the electrical resistance-temperature plot obtained by measurement, the temperature at which the resistance value becomes twice the resistance value at room temperature (20° C.) is defined as the Curie point.

### (1-2. Electrode Layer)

The first electrode layer 102a is provided on the first end surface 101a, and the second electrode layer 102b is provided on the second end surface 101b. By applying a voltage between the first electrode layer 102a and the second electrode layer 102b, it is possible to cause the honeycomb structure portion to generate heat using Joule heat.

Specifically, the first electrode layer 102a covers a part or all of the surface of the partition walls 106 forming the first end surface 101a. The second electrode layer 102b covers a part or all of the surface of the partition walls 106 forming the second end surface 101b. In order to easily spread the current over the entire first end surface 101a, it is preferable that the first electrode layer 102a covers 80% or more, more preferably 90% or more, and even more preferably 99 or more of the area of the first end surface 101a excluding the openings of the cells 104 (that is, partition wall portions and outer peripheral wall portion). Similarly, in order to easily spread the current over the entire second end surface 101b, it is preferable that the second electrode layer 102b covers 80% or more, more preferably 90% or more, and even more preferably 99 or more of the area of the second end surface 101b excluding the openings of the cells 104 (that is, partition wall portions and outer peripheral wall portion).

The first electrode layer 102a and the second electrode layer 102b are not particularly limited, but for example, a metal or alloy containing at least one selected from Cu, Ag, Al, Ni, and Si can be used. In a preferred embodiment, the first electrode layer 102a and the second electrode layer 102b contain one or more selected from pure aluminum, an aluminum alloy, and stainless steel. Further, it is also possible to use an ohmic electrode that can make ohmic contact with the outer peripheral wall 103 and/or the partition walls 106 having PTC characteristics. The ohmic electrode contains, for example, at least one selected from Al, Au, Ag, and In as a base metal, and an ohmic electrode containing at least one selected from Ni, Si, Zn, Ge, Sn, Se, and Te for n-type semiconductors as a dopant can be used. Further, the first electrode layer 102a and the second electrode layer 102b may have a single layer structure or may have a laminated structure of two or more layers. When the first electrode layer 102a and the second electrode layer 102b have a laminated structure of two or more layers, the material of each layer may be the same or different. In preferred embodiments, the first electrode layer 102a and the second electrode layer 102b may have a single layer of pure aluminum, a two-layer structure of Al—Ni alloy layer and pure silver layer, or a two-layer structure of Al—Ni alloy layer and pure aluminum layer.

The thicknesses of the first electrode layer 102a and the second electrode layer 102b are not particularly limited, and can be appropriately set depending on the method of forming the first electrode layer 102a and the second electrode layer 102b. Examples of methods for forming the first electrode layer 102a and the second electrode layer 102b include metal deposition methods such as sputtering, vapor deposition, electrolytic deposition, and chemical deposition. Further, the electrode layer can also be formed by applying an electrode paste and then baking it, or by thermal spraying. Further, the electrode layer may be formed by joining a metal plate or an alloy plate such as a punched metal plate having through holes at locations corresponding to the openings of the cells.

The average thicknesses of the first electrode layer 102a and the second electrode layer 102b is not limited, and it can be, for example, 5 μm or more and 100 μm or less, respectively. By setting the lower limit of the average thickness of the first electrode layer 102a and the second electrode layer 102b to 5 μm or more, preferably 10 μm or more, and more preferably 20 μm or more, there is an advantage that abnormal heat generation in the electrode layers can be avoided. By setting the upper limit of the average thickness of the first electrode layer 102a and the second electrode layer 102b to 100 μm or less, preferably 80 μm or less, and more preferably 60 μm or less, there is an advantage that the rigidity of the electrode layers can be suppressed and they are difficult to peel off from the end surface of the honeycomb structure portion.

The average thickness of the first electrode layer 102a is measured by the following procedure. First, a cross-sectional image of the first electrode layer is obtained at a magnification of approximately 50 times using a scanning electron microscope or the like. The cross-section is parallel to the direction in which the flow paths of the honeycomb structure portion extend. In the cross-sectional image, as illustrated in the partially enlarged view of FIG. 1B, since the first electrode layer is visible for each partition wall, a thickness T₁ is measured at two locations per cross-sectional image for each of the first electrode layer at the central position of the length in the direction perpendicular to the direction in which the flow paths of the partition wall forming the first end surface covered by the first electrode layer extend. The direction of the thickness is parallel to the direction in which the flow paths extend. Then, a large number of cross-sectional images of the first electrode layer are uniformly acquired from the vicinity of the first end surface of the heater element, and the thickness T₁ is measured at ten or more locations of the first electrode layer in total. The average value of all the measured thicknesses T₁ is taken as the average thickness of the first electrode layer. The average thickness of the second electrode layer 102b is also measured using the same procedure.

The lower limit of the volume resistivity at 25° C. of the first electrode layer 102a and the second electrode layer 102b is not particularly limited, but a normally achievable range is 1.0×10⁻⁷ Ω·cm or more. From the viewpoint of ensuring sufficient current spread in the plane and uniform temperature distribution, the upper limit of the volume resistivity of the first electrode layer 102a and the second electrode layer 102b at 25° C. is preferably 1.0×10⁻⁵ Ω·cm or less, preferably 1.0×10⁻⁶ Ω·cm or less, more preferably 5.0×10⁻⁷ Ω·cm or less, and even more preferably 3.0×10⁻⁷ Ω·cm or less. Therefore, the range of the volume resistivity of the first electrode layer 102a and the second electrode layer 102b at 25° C. can be, for example, 1.0×10⁻⁷ Ω·cm or more and 1.0×10⁻⁵ Ω·cm or less. As used herein, the volume resistivity at 25° C. of the first electrode layer 102a and the second electrode layer 102b is measured according to JIS K6271: 2008.

### (1-3. First and Second Moisture Absorbent-Containing Layers)

The first moisture absorbent-containing layer 107a covers a part of the outer surface of the first electrode layer 102a, and the second moisture absorbent-containing layer 107b covers a part of the outer surface of the second electrode layer 102b. This makes it possible to suppress the occurrence of short circuits between the electrode layers due to migration of metal components in the electrode layers. The outer surface of the first electrode layer 102a refers to the surface opposite to the surface where the first electrode layer 102a is in contact with the first end surface 101a. The outer surface of the second electrode layer 102b refers to the surface opposite to the surface where the second electrode layer 102b is in contact with the second end surface 101b.

The first moisture absorbent-containing layer 107a covers “a part” of the outer surface of the first electrode layer 102a because the portion of the outer surface of the first electrode layer 102a to which a first terminal 109a is to be connected should not be covered by the first moisture absorbent-containing layer 107a, and therefore the surface is not entirely covered. Similarly, the second moisture absorbent-containing layer 107b covers “a part” of the outer surface of the second electrode layer 102b because the portion of the outer surface of the second electrode layer 102b to which a second terminal 109b is to be connected should not be covered by the second moisture absorbent-containing layer 107b, and therefore the surface is not entirely covered.

In order to enhance the short circuit prevention effect, it is preferable for the first moisture absorbent-containing layer 107a to cover 80% or more, more preferable to cover 90% or more, and even more preferably to cover 99% or more, of the area of the outer surface of the first electrode layer 102a where the first terminal 109a is not connected. Similarly, in order to enhance the short circuit prevention effect, it is preferable for the second moisture absorbent-containing layer 107b to cover 80% or more, more preferable to cover 90% or more, and even more preferably to cover 99% or more, of the area of the outer surface of the second electrode layer 102b where the second terminal 109b is not connected.

The first moisture absorbent-containing layer 107a and the second moisture absorbent-containing layer 107b are preferably insulating. The vicinity of the first end surface 101a and the vicinity of the second end surface 101b are areas where foreign flying objects tend to adhere, and if the flying objects have conductivity, they may cause a short circuit. When the first moisture absorbent-containing layer 107a and the second moisture absorbent-containing layer 107b are insulating, short circuits caused by flying objects can be prevented. As used herein, the fact that the first moisture absorbent-containing layer 107a and the second moisture absorbent-containing layer 107b are insulating means that the first moisture absorbent-containing layer 107a and the second moisture absorbent-containing layer 107b each satisfy the following conditions regarding electrical resistance.

Assuming the coordinate value of the center of gravity O of the first end surface 101a (second end surface 101b) is 0, a coordinate axis is taken in the direction from the center of gravity O toward the outer peripheral contour C of the first end surface 101a (second end surface 101b), and the coordinate value on the outer peripheral contour C is assumed to be 1.00R. Then, the electrical resistance between two points on the outer surface of the first moisture absorbent-containing layer 107a (second moisture absorbent-containing layer 107b) that are the farthest apart between the line segments connecting the center of gravity O and an arbitrary point D with a coordinate value of 0.90R at 25° C. is measured by the shunt method (see FIG. 1A). The outer surface of the first moisture absorbent-containing layer 107a (second moisture absorbent-containing layer 107b) refers to the surface opposite to the surface where the first moisture absorbent-containing layer 107a (second moisture absorbent-containing layer 107b) contacts the first electrode layer 102a (second electrode layer 102b). Next, the point D is rotated by 30° with the center of gravity O as the center of rotation, and the electrical resistance is measured in the same way. In this way, while rotating the point D by 30° each time, the electrical resistance between the center of gravity O and the point D is measured for one circle (12 locations). When the lower limit of the electrical resistance at the 12 locations obtained is 1.0×10⁴Ω or more, the first moisture absorbent-containing layer 107a (second moisture absorbent-containing layer 107b) is defined as insulating.

In addition, if the first terminal 109a (second terminal 109b) exists between the line segments connecting the point D and the center of gravity O at the location where point D has been rotationally moved, the point D is further rotationally moved to a position where the first terminal 109a (second terminal 109b) does not exist, and then the measurement is performed.

It is preferable that the lower limit of the electrical resistance of the first moisture absorbent-containing layer 107a and the second moisture absorbent-containing layer 107b be 1.0×10⁵Ω or more, and more preferably 5.0×10⁵Ω or more. Although the upper limit of electrical resistance is not particularly set for the first moisture absorbent-containing layer 107a and the second moisture absorbent-containing layer 107b, when electrical resistance is measured using the above procedure, the range of electrical resistance is normally 1.0×10⁵Ω to 1.0×10⁷Ω, and is typically 2.0×10⁵Ω to 1.0×10⁶Ω.

As used herein, a moisture absorbent refers to a substance that has the property of adsorbing 5 g/g or more of water per 1 g of its own dry mass when left for one hour in an environment at room temperature (25° C.) and 50% relative humidity. The moisture absorbent preferably has the function of adsorbing moisture at a temperature of −20 to 40° C. and releasing it at a high temperature of 60° C. or higher, preferably 70 to 180° C. In this way, when the moisture absorbent has the function of adsorbing moisture at low temperatures and desorbing moisture at high temperatures, the moisture absorbent can be used many times by repeating energization and de-energization.

There is no particular limitation on the type of moisture absorbent contained in the first moisture absorbent-containing layer 107a and the second moisture absorbent-containing layer 107b, and mention can be made to silica gel, sepiolite, calcium oxide, diatomaceous earth, activated carbon, activated clay, zeolite, white carbon, calcium chloride, magnesium chloride, potassium acetate, dibasic sodium phosphate, sodium citrate and water-absorbing polymer, crystalline aluminum silicate, amorphous aluminum silicate, and the like. Among these, zeolite and amorphous aluminum silicate are preferable, and amorphous aluminum silicate is more preferable because they can release moisture in a relatively low temperature range. One type of moisture absorbent may be used alone, or two or more types may be used in combination. The above-mentioned moisture absorbents are merely examples, and the present invention is not limited thereto.

The first moisture absorbent-containing layer 107a and the second moisture absorbent-containing layer 107b may contain a binder. Although the binder includes both organic binders and inorganic binders, inorganic binders are preferred. The type of inorganic binder is not particularly limited, and mention can be made to alumina sol, silica sol, montmorillonite, boehmite, gamma alumina, and attapulgite. These may be used alone or in combination of two or more. Among these, alumina sol and silica sol are preferable, and silica sol is more preferable because adhesive strength can be easily ensured.

The first moisture absorbent-containing layer 107a and the second moisture absorbent-containing layer 107b may comprise, in addition to the moisture absorbent, a functional material having a function of adsorbing components to be removed in the air, such as carbon dioxide and/or organic gas components. In particular, it is preferable to contain a functional material capable of adsorbing carbon dioxide and/or organic gas components at −20 to 40° C. and releasing them at a high temperature of 60° C. or higher, preferably 70 to 180° C. In this way, when the functional material has the function of adsorbing the component to be removed in the air at a low temperature and desorbing it at a high temperature, the functional material can be used many times by repeating energization and de-energization.

Organic gas components contained in the air that can be removed include, for example, volatile organic compounds (VOC) and odor components. As specific examples of harmful volatile components, mention can be made to ammonia, acetic acid, isovaleric acid, nonenal, formaldehyde, toluene, xylene, paradichlorobenzene, ethylbenzene, styrene, chlorpyrifos, di-n-butyl phthalate, tetradecane, di-2-ethylhexyl phthalate, diazinon, acetaldehyde, 2-(1-methylpropyl)phenyl N-methylcarbamate, and the like.

Some of the moisture absorbents mentioned above have these functions, and although some of the descriptions overlap, examples of such functional material include zeolite, silica gel, activated carbon, alumina, silica, low crystalline clay, and amorphous aluminum silicate complex. The type of functional material may be selected as appropriate depending on the type of component to be removed. One type of functional material may be used alone, or two or more types may be used in combination.

The first moisture absorbent-containing layer 107a and the second moisture absorbent-containing layer 107b may further contain a catalyst, for the purpose of purifying the components to be removed or increasing the ability of functional materials (including moisture absorbents) to capture the components to be removed. The catalyst preferably has a function capable of promoting redox reactions. Examples of catalysts having such functions include metal catalysts such as Pt, Pd, and Ag, and oxide catalysts such as CeO₂ and ZrO₂. One type of catalyst may be used alone, or two or more types may be used in combination.

The average thickness of at least one of the first moisture absorbent-containing layer 107a and the second moisture absorbent-containing layer 107b, preferably both, can be, for example, 10 μm or more and 500 μm or less, although not limited to. By setting the lower limit of the average thickness of at least one, preferably both, of the first moisture absorbent-containing layer 107a and the second moisture absorbent-containing layer 107b to 10 μm or more, preferably 30 μm or more, more preferably 50 μm or more, there can be obtained an advantage of ensuring insulation and ensuring sufficient moisture absorption capacity. By setting the upper limit of the average thickness of at least one of the first moisture absorbent-containing layer 107a and the second moisture absorbent-containing layer 107b, and desirably both, to 500 μm or less, preferably 300 μm or less, and more preferably 200 μm or less, the rigidity of the moisture absorbent-containing layer can be reduced, resulting in an advantage in that it is less likely to peel off.

The average thickness of the first moisture absorbent-containing layer 107a is measured by the following procedure. First, a cross-sectional image of the first functional material-containing layer is obtained at a magnification of approximately 50 times using a scanning electron microscope or the like. The cross-section is parallel to the direction in which the flow paths of the honeycomb structure portion extend. In the cross-sectional image, as illustrated in the partially enlarged view of FIG. 1B, since the first moisture absorbent-containing layer is visible for each partition wall, a thickness T₂ is measured at two locations per cross-sectional image for each of the first moisture absorbent-containing layer at the central position of the length in the direction perpendicular to the direction in which the flow paths of the partition walls forming the first end surface indirectly covered by the first moisture absorbent-containing layer extend. The direction of the thickness is parallel to the direction in which the flow paths extend. Then, a large number of cross-sectional images of the first moisture absorbent-containing layer are uniformly acquired from the vicinity of the first end surface of the heater element, and the thickness T₂ is measured at ten or more locations of the first moisture absorbent-containing layer in total. The average value of all the measured thicknesses T₂ is taken as the average thickness of the first moisture absorbent-containing layer. The average thickness of the second moisture absorbent-containing layer 107b is also measured using the same procedure.

The first moisture absorbent-containing layer 107a preferably covers not only the outer surface of the first electrode layer 102a but also a part or all of the other exposed surface (for example, a surface parallel to the thickness direction of the first electrode layer 102a) of the first electrode layer 102a, and more preferably covers the entire exposed surface. Similarly, the second moisture absorbent-containing layer 107b preferably covers not only the outer surface of the second electrode layer 102b but also a part or all of the other exposed surface (for example, a surface parallel to the thickness direction of the second electrode layer 102b) of the second electrode layer 102b, and more preferably covers the entire exposed surface.

### (1-4. Terminals)

A first terminal 109a is connected to a portion of the outer surface of the first electrode layer 102a that is not covered by the first moisture absorbent-containing layer 107a. A second terminal 109b is connected to a portion of the outer surface of the second electrode layer 102b that is not covered by the second moisture absorbent-containing layer 107b. The first terminal 109a and the second terminal 109b are preferably disposed on the outer periphery.

The connection method between the first electrode layer 102a and the first terminal 109a and between the second electrode layer 102b and the second terminal 109b is not particularly limited as long as they are electrically conductive. For example, the connection can be made by welding, brazing, mechanical contact, or the like. The material of the first terminal 109a and the second terminal 109b is not particularly limited, but may be made of metal, for example. As the metal, single metals and alloys can be used, but from the viewpoint of selecting a material that is resistant to oxidation in a humid environment, resistant to migration or electrolytic corrosion even under humid conditions, and easy to join with electrodes, it is preferable to contain one or more selected from pure aluminum, aluminum alloy and stainless steel, and for example, it can be made of pure aluminum, aluminum alloy, or stainless steel. In addition, alloys containing at least one selected from the group consisting of Cr, Fe, Co, Ni, Cu, and T₁ can also be used, and among them, Fe—Ni alloys and phosphor bronze can be preferably used. It is preferable that the terminal be made of a material similar to the electrode layer on the end surface from the viewpoint of avoiding electrolytic corrosion. In one example, both the electrode layer and the terminal are preferably made of pure aluminum and/or an aluminum alloy.

Although the shape of the first terminal 109a and the second terminal 109b is not limited, it can be, for example, flat. In that case, the plate thickness of the terminal is not limited, but it can be, for example, 0.1 to 4 mm, preferably 0.3 to 2 mm.

The area of the portion of the first end surface 101a covered (indirectly) by the first terminal 109a due to the first terminal 109a being connected to the first electrode layer 102a is not particularly limited, but if the first terminal 109a is too small, it will be difficult to connect a current-carrying component to the first terminal 109a. Conversely, if the first terminal 109a is too large, the area that closes the openings of the cells 104 becomes large, and the flow rate of air that can flow into the heater element 100 decreases. Therefore, the lower limit of the ratio of the area that the first terminal 109a covers the first end surface 101a to the area of the first end surface 101a is preferably 0.5% or more, more preferably 1% or more, and even more preferably 2% or more. Further, the upper limit of the ratio of the area that the first terminal 109a covers the first end surface 101a to the area of the first end surface 101a is preferably 10% or less, more preferably 8% or less, and even more preferably 5% or less. Therefore, the ratio of the area that the first terminal 109a covers the first end surface 101a to the area of the first end surface 101a can be, for example, 0.5% or more and 10% or less. The same applies to the ratio of the area that the second terminal 109b covers the second end surface 101b to the area of the second end surface 101b.

The lower limit of the volume resistivity at 25° C. of the first terminal 109a and the second terminal 109b is not particularly limited, but a normally achievable range is 1.0×10⁻⁷ Ω·cm or more. From the viewpoint of reducing heat generation and energy loss at the terminals, the upper limit of the volume resistivity of the first terminal 109a and the second terminal 109b at 25° C. is preferably 1.0×10⁻⁶ Ω·cm or less, preferably 5.0×10⁻⁷ Ω·cm or less, more preferably 3.0×10⁻⁷ Ω·cm or less, and even more preferably 2.0×10⁻⁷ Ω·cm or less. Therefore, the range of the volume resistivity of the first terminal 109a and the second terminal 109b at 25° C. can be, for example, from 1.0×10⁻⁷ Ω·cm to 1.0×10⁻⁶ Ω·cm. As used herein, the volume resistivity at 25° C. of the first terminal 109a and the second terminal 109b is measured according to JIS K6271: 2008.

### (1-5. Third and Fourth Moisture Absorbent-Containing Layers)

A third moisture absorbent-containing layer 111a covers a part of the outer surface of the first terminal 109a, and a fourth moisture absorbent-containing layer 111b covers a part of the outer surface of the second terminal 109b. This makes it possible to suppress the occurrence of short circuits due to migration of metal components in the terminals. The outer surface of the first terminal 109a refers to the surface opposite to the surface where the first terminal 109a is in contact with the first electrode layer 102a. The outer surface of the second terminal 109b refers to the surface opposite to the surface where the second terminal 109b is in contact with the second electrode layer 102b.

The third moisture absorbent-containing layer 111a covers “a part” of the outer surface of the first terminal 109a because the portion of the outer surface of the first terminal 109a to which a current-carrying component 105a is to be connected should not be covered by the third moisture absorbent-containing layer 111a, and therefore the surface is not entirely covered. Similarly, the fourth moisture absorbent-containing layer 111b covers “a part” of the outer surface of the second terminal 109b because the portion of the outer surface of the second terminal 109b to which a current-carrying component 105b is to be connected should not be covered by the fourth moisture absorbent-containing layer 111b, and therefore does not cover the entire surface.

In order to enhance the short circuit prevention effect, it is preferable for the third moisture absorbent-containing layer 111a to cover 80% or more, more preferable to cover 90% or more, and even more preferably to cover 99% or more, of the area of the outer surface of the first terminal 109a where the current-carrying component 105a is not connected. Similarly, in order to enhance the short circuit prevention effect, it is preferable for the fourth moisture absorbent-containing layer 111b to cover 80% or more, more preferable to cover 90% or more, and even more preferably to cover 99% or more, of the area of the outer surface of the second terminal 109b where the current-carrying component 105b is not connected.

The third moisture absorbent-containing layer 111a and the fourth moisture absorbent-containing layer 111b are preferably insulating for the same reasons as the first moisture absorbent-containing layer 107a and the second moisture absorbent-containing layer 107b. The third moisture absorbent-containing layer 111a and the fourth moisture absorbent-containing layer 111b being insulating means that the third moisture absorbent-containing layer 111a and the fourth moisture absorbent-containing layer 111b each satisfy the following conditions regarding electrical resistance.

The electrical resistance at 25° C. between any two points separated by 3 mm on the outer surface of the third moisture absorbent-containing layer 111a (fourth moisture absorbent-containing layer 111b) is measured by the shunt method. However, the distance between the two points is selected such that the current-carrying component 105a does not exist between the line segments connecting the two points. If the lower limit of the electrical resistance obtained is 1.0×10⁴Ω or more when measuring at three different measurement points, it is defined that the third moisture absorbent-containing layer 111a (fourth moisture absorbent-containing layer 111b) is insulating.

It is preferable that the lower limit of the electrical resistance of the third moisture absorbent-containing layer 111a and the fourth moisture absorbent-containing layer 111b is 1.0×10⁵Ω or more, and more preferably 5.0×10⁵Ω or more. Although the upper limit of electrical resistance is not particularly set for the third moisture absorbent-containing layer 111a and the fourth moisture absorbent-containing layer 111b, when electrical resistance is measured using the above procedure, the range of electrical resistance is usually 5.0×10⁵Ω to 1.0×10⁷Ω, and is typically 1.0×10⁶Ω to 5.0×10⁶Ω.

The type of the moisture absorbent contained in the third moisture absorbent-containing layer 111a and the fourth moisture absorbent-containing layer 111b are as described in the description regarding the first moisture absorbent-containing layer 107a and the second moisture absorbent-containing layer 107b, including the preferred embodiments.

The third moisture absorbent-containing layer 111a and the fourth moisture absorbent-containing layer 111b may contain a binder. The binder is as described in the description regarding the first moisture absorbent-containing layer 107a and the second moisture absorbent-containing layer 107b, including the preferred embodiments.

The third moisture absorbent-containing layer 111a and the fourth moisture absorbent-containing layer 111b may comprise, in addition to the moisture absorbent, a functional material having a function of adsorbing components to be removed in the air, such as carbon dioxide and/or organic gas components. The functional material, including the preferred embodiments, is as described in the description of the first moisture absorbent-containing layer 107a and the second moisture absorbent-containing layer 107b.

The third moisture absorbent-containing layer 111a and the fourth moisture absorbent-containing layer 111b may further contain a catalyst, for the purpose of purifying components to be removed or enhancing the ability of functional materials (including moisture absorbents) to capture components to be removed. The catalyst is as described in the description regarding the first moisture absorbent-containing layer 107a and the second moisture absorbent-containing layer 107b, including the preferred embodiments.

Although the average thickness of the third moisture absorbent-containing layer 111a and the fourth moisture absorbent-containing layer 111b is not limited, it can be, for example, 10 μm or more and 500 μm or less. By setting the lower limit of the average thickness of the third moisture absorbent-containing layer 111a and the fourth moisture absorbent-containing layer 111b to be 10 μm or more, preferably 20 μm or more, and more preferably 30 μm or more, there is an advantage that insulation properties can be ensured and sufficient moisture absorption capacity can be ensured. By setting the upper limit of the average thickness of the third moisture absorbent-containing layer 111a and the fourth moisture absorbent-containing layer 111b to 500 μm or less, preferably 300 μm or less, and more preferably 200 μm or less, there is an advantage that the rigidity of the functional material-containing layer can be reduced, making it difficult to peel off.

The average thickness of the third moisture absorbent-containing layer 111a is determined using a cross-sectioning method based on JIS K5600-1-7 (2014), and the average value when the thickness of the third functional material-containing layer is measured at five or more arbitrary locations is defined as the average thickness of the third functional material-containing layer. The average thickness of the fourth moisture absorbent-containing layer 111b is also measured using the same procedure.

The third moisture absorbent-containing layer 111a preferably covers not only the outer surface of the first terminal 109a but also a part or all of the other exposed surface (for example, a plane parallel to the plate thickness direction when the first terminal 109a is a flat plate) of the first terminal 109a, and more preferably covers the entire exposed surface. Similarly, the fourth moisture absorbent-containing layer 111b preferably covers not only the outer surface of the second terminal 109b but also a part or all of the other exposed surface (for example, a surface parallel to the plate thickness direction when the second terminal 109b is a flat plate) of the second terminal 109b, and more preferably covers the entire surface.

### (1-6. Fifth Moisture Absorbent-Containing Layer)

From the viewpoint of increasing the overall water absorption capacity of the heater element 100, it is preferable to have a fifth moisture absorbent-containing layer 113 that covers a part or the whole of the surface of the partition walls 106 that form the flow paths inside the cells 104. The greater the water absorption is, the greater the effect of preventing short circuits is, and also the effect of improving the indoor environment is enhanced better when the purpose is to adjust humidity.

In order to enhance the effect of preventing short circuits and the effect of improving the indoor environment, the fifth moisture absorbent-containing layer 113 preferably covers 80% or more, preferably covers 90% or more, and even more preferably covers 99% or more of the surface area of the partition walls 106 that form the flow paths inside the cells 104. The ratio of the area covered by the fifth moisture absorbent-containing layer 113 to the area of the surface of the partition walls 106 forming the flow paths inside the cells 104 is measured by the following procedure.
(1) From the heater element 100, cut out a cross-section that passes through the center of gravity O of the first end surface 101a (second end surface 101b) and is parallel to the direction in which the cells 104 extend.
(2) Image the obtained cross-section, and for each cell 104, by image analysis, determine the ratio of the length of the portion covered by the fifth moisture absorbent-containing layer 113 to the length of the surface of the partition wall 106 that forms the flow path inside the cell 104 in the direction in which the cell extends. The average value of the ratio measured for all cells 104 in the cross-section is regarded as the ratio of the area covered by the fifth moisture absorbent-containing layer 113 to the area of the surface of the partition walls 106 that form the flow paths inside the cells 104. For image analysis, on images taken with an optical microscope (50× magnification), a method can be adopted in which the luminance of each pixel constituting the fifth functional material-containing layer and the partition walls is measured, and a binarization process is performed using the average value thereof as a threshold value to distinguish the region of the fifth functional material-containing layer and the partition walls. By specifying the length of the part where the partition wall is covered with the fifth functional material-containing layer and dividing it by the cell length (length of the honeycomb structure), the ratio of the length of the portion covered by the fifth functional material-containing layer can be determined.

The fifth moisture absorbent-containing layer 113 is preferably insulating for the same reason as the first moisture absorbent-containing layer 107a and the second moisture absorbent-containing layer 107b. The fact that the fifth moisture absorbent-containing layer 113 is insulating means that the fifth moisture absorbent-containing layer 113 satisfies the following conditions.

A cross-section parallel to the direction in which the flow paths of the honeycomb structure portion extend is cut out from the heater element 100, and the fifth moisture absorbent-containing layer 113 covering the surface of the partition wall 106 is exposed. For the surface of the fifth moisture absorbent-containing layer 113 covering an arbitrary cell 104, the electrical resistance at 25° C. between two points separated by 3 mm in the direction in which the cell 104 extends is measured for five locations by the shunt method. When the obtained electrical resistance is 1.0×10⁴Ω or more, the fifth moisture absorbent-containing layer 113 covering the cell is defined as having insulating property. The fifth moisture absorbent-containing layer 113 covering other cells can be measured in the same manner, but if it is clear that the material forming the fifth moisture absorbent-containing layer 113 is substantially the same, the results will be the same, so the measurement may be omitted.

The lower limit of the electrical resistance of the fifth moisture absorbent-containing layer 113 is preferably 1.0×10⁵Ω or more, more preferably 5.0×10⁵Ω or more when the electrical resistance is measured using the above procedure. Although there is no particular upper limit for the electrical resistance of the fifth moisture absorbent-containing layer 113, when the electrical resistance is measured using the above procedure, the range of electrical resistance is usually 5.0×10⁵Ω to 1.0×10⁷Ω, and is typically 1.0×10⁶Ω to 5.0×10⁶Ω.

The type of the absorbent contained in the fifth moisture absorbent-containing layer 113 are as described in the description regarding the first moisture absorbent-containing layer 107a and the second moisture absorbent-containing layer 107b, including the preferred embodiments.

The fifth moisture absorbent-containing layer 113 may contain a binder. The binder is as described in the description regarding the first moisture absorbent-containing layer 107a and the second moisture absorbent-containing layer 107b, including the preferred embodiments.

The fifth moisture absorbent-containing layer 113 may comprise, in addition to the moisture absorbent, a functional material having a function of adsorbing components to be removed in the air, such as carbon dioxide and/or organic gas components. The functional material, including the preferred embodiments, is as described in the description of the first moisture absorbent-containing layer 107a and the second moisture absorbent-containing layer 107b.

The fifth moisture absorbent-containing layer 113 may further contain a catalyst, for the purpose of purifying components to be removed or enhancing the ability of functional materials (including moisture absorbents) to capture components to be removed. The catalyst is as described in the description regarding the first moisture absorbent-containing layer 107a and the second moisture absorbent-containing layer 107b, including the preferred embodiments.

Although the average thickness of the fifth moisture absorbent-containing layer 113 is not limited, it can be, for example, 10 μm or more and 500 μm or less. By setting the lower limit of the average thickness of the fifth moisture absorbent-containing layer 113 to be 10 μm or more, preferably 20 μm or more, and more preferably 30 μm or more, there is an advantage that insulation properties can be ensured and sufficient moisture absorption capacity can be ensured. By setting the upper limit of the average thickness of the fifth moisture absorbent-containing layer 113 to 500 μm or less, preferably 300 μm or less, and more preferably 200 μm or less, there is an advantage that the rigidity of the functional material-containing layer can be reduced, making it difficult to peel off.

The average thickness of the fifth moisture absorbent-containing layer 113 is measured by the following procedure. First, a cross-sectional image of the fifth moisture absorbent-containing layer 113 is obtained using a scanning electron microscope or the like at a magnification of approximately 50 times. The cross-section is parallel to the direction in which the flow paths of the honeycomb structure portion extend. In the cross-sectional image, as illustrated in the partially enlarged view of FIG. 1B, since the fifth moisture absorbent-containing layer 113 is visible at two locations sandwiching each partition wall, for each of the fifth moisture absorbent-containing layer 113, by dividing the entire cross-sectional area from the first end surface 101a to the second end surface 101b by the length from the first end surface 101a to the second end surface 101b of the partition wall that is covered by the fifth functional material-containing layer, the thickness of each fifth moisture absorbent-containing layer 113 is calculated. Then, a large number of cross-sectional images of the fifth moisture absorbent-containing layer 113 are uniformly acquired from the heater element, and the thickness of the fifth moisture absorbent-containing layer 113 at five or more locations is measured. The average value of all the measured thicknesses of the fifth moisture absorbent-containing layer 113 is defined as the average thickness of the fifth functional material-containing layer.

It should be noted the above-mentioned classifications of the various absorbent-containing layers from the first to the fifth are for convenience. Therefore, it is not necessary that separate layers be formed, and there is no hindrance to absorbent-containing layers of different types being continuous, and there is no hindrance to absorbent-containing layers of different types being formed simultaneously in a single process.

### (1-7. Moisture Absorption Characteristics of Heater Elements)

As described above, the heater element according to one embodiment of the present invention comprises, in addition to the first moisture absorbent-containing layer and the second moisture absorbent-containing layer, a third moisture absorbent-containing layer, a fourth moisture absorbent-containing layer and a fifth moisture absorbent-containing layer, as appropriate. The moisture absorption characteristics of the heater element depend on the total mass of the moisture absorbent contained in these moisture absorbent-containing layers, and the more moisture absorbent is, the greater the maximum water absorption amount is. From the viewpoint of the heater element exhibiting excellent moisture absorption performance, the lower limit of the maximum water absorption amount (g) of the heater element per unit volume (1 liter) of the honeycomb structure portion is preferably 20 g/liter or more, more preferably 100 g/liter or more, and even more preferably 150 g/liter or more. In addition, from the viewpoint of ensuring a large cell opening area to reduce the air resistance and reducing the rigidity of the moisture absorbent-containing layer to make it less likely to peel off, the upper limit of the maximum water absorption (g) of the heater element per unit volume (1 liter) of the honeycomb structure portion is preferably 400 g/liter or less, more preferably 350 g/liter or less, and even more preferably 300 g/liter or less. The maximum water absorption amount (g) of the heater element per unit volume (1 liter) of the honeycomb structure portion can be in the range of, for example, 20 g/liter to 400 g/liter.

The maximum water absorption of a heater element is measured by the following procedure. A heater element is prepared from which a frame, which will be described later, has been removed. Next, this heater element is dried at 180° C. for at least 2 hours, and then left in a thermo-hygrostat kept at 25° C. and a relative humidity of at least 90% for one hour, and the amount of water absorbed by the heater element is determined from the change in mass before and after. The amount of water absorption at this time is defined as the maximum amount of water absorption. Then, the maximum amount of water absorption (g) is divided by the outer dimension (liters) of the honeycomb structure portion to calculate the maximum amount of water absorption per unit volume (g/liter).

In addition, the maximum water absorption capacity of the heater element depends on the water absorption performance of the moisture absorbent contained in the first moisture absorbent-containing layer and the second moisture absorbent-containing layer, as well as the moisture absorbent contained in the third moisture absorbent-containing layer, the fourth moisture absorbent-containing layer and the fifth moisture absorbent-containing layer, if these layers are present.

In the heater element according to embodiments of the present invention, assuming a region having a length of 0.5 cm from the outer surface of the first moisture absorbent-containing layer toward the second end surface in a direction in which the cells extend (the direction in which the flow paths extend) is a first region, in order to ensure excellent moisture absorption performance, the lower limit of the maximum water absorption amount (g) per unit volume (1 liter) of the first region is preferably 90 g/liter or more, more preferably 100 g/liter or more, and even more preferably 120 g/liter or more. The upper limit of the maximum water absorption (g) per unit volume (1 liter) of the first region is preferably 200 g/liter or less, more preferably 180 g/liter or less, and even more preferably 160 g/liter or less, in order to shorten the time for the regeneration process of releasing water and drying. Therefore, the maximum water absorption amount (g) per unit volume (1 liter) of the first region can be in the range of, for example, 90 g/liter to 200 g/liter.

Similarly, assuming a region having a length of 0.5 cm from the outer surface of the second moisture absorbent-containing layer toward the first end surface in a direction in which the cells extend (the direction in which the flow paths extend) is a second region, in order to ensure excellent moisture absorption performance, the lower limit of the maximum water absorption amount (g) per unit volume (1 liter) of the second region is preferably 90 g/liter or more, more preferably 100 g/liter or more, and even more preferably 120 g/liter or more. The upper limit of the maximum water absorption (g) per unit volume (1 liter) of the second region is preferably 200 g/liter or less, more preferably 180 g/liter or less, and even more preferably 160 g/liter or less, in order to shorten the time for the regeneration process of releasing water and drying. Therefore, the maximum water absorption amount (g) per unit volume (1 liter) of the second region can be in the range of, for example, 90 g/liter to 200 g/liter.

As used herein, the maximum water absorption amount of the first region (second region) of the heater element is measured by the following procedure. A heater element is prepared from which a frame, which will be described later, has been removed. Next, a first terminal (second terminal) is removed from the heater element, and then a first region (second region) is cut and extracted from the heater element. The first region (second region) is dried at 180° C. for more than 2 hours, and then left in a thermo-hygrostat at 25° C. and a relative humidity of 90% or more for one hour, and the amount of water absorbed by the first region (second region) is determined from the change in mass before and after. The amount of water absorption at this time is defined as the maximum amount of water absorption. The maximum amount of water absorption (g) is then divided by the outer dimension (liters) of the first region (second region) to calculate the maximum amount of water absorption per unit volume (g/liter).

### (1-8. Current-Carrying Components)

The first terminal 109a and the second terminal 109b can be connected to current-carrying components 105a, 105b, respectively. Examples of conductive materials constituting the current-carrying components 105a, 105b include stainless steel, aluminum, aluminum alloy, copper alloy, and copper. The connection method between the first terminal 109a and the current-carrying component 105a and between the second terminal 109b and the current-carrying component 105b is not particularly limited as long as both are electrically conductive, and for example, the connection can be made by welding, brazing, mechanical contact, or the like. In one embodiment, the current-carrying components 105a, 105b can by an electric wire itself between a power source and the first terminal 109a (second terminal 109b), that is, a copper wire, a copper alloy wire, an aluminum wire, an aluminum alloy wire, or a stainless-steel wire. In another embodiment, the current-carrying components 105a, 105b may be intermediary components that connect an electric wire and the first terminal 109a (second terminal 109b). The intermediary component can be connected to the electric wire by, for example, welding, soldering, brazing, caulking, bolting, or other methods.

### 2. Heater Element Assembly

A heater element according to an embodiment of the present invention may be provided as a heater element assembly held in a frame. The protective effect of the frame prevents the heater element from being damaged when it is installed in a ventilation duct. Further, it is possible to form a shape that is easy to install in an air conditioning system while ensuring electrical insulation with surrounding components.

There are no particular limitations on the frame that holds the heater element, but the frame in one embodiment can be configured so that the heater element can be clamped from the first end surface side and the second end surface side. The frame according to another embodiment can be configured so as to be able to hold the heater element from the outer peripheral surface side of the outer peripheral wall.

### (2-1. Heater Element Assembly Comprising an End Surface Clamping Type Frame)

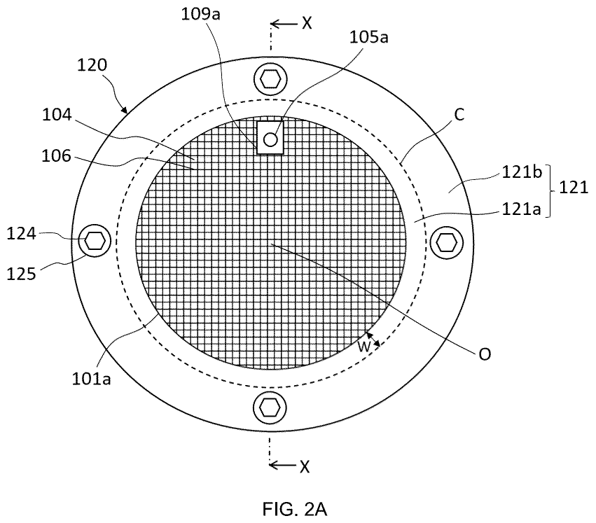

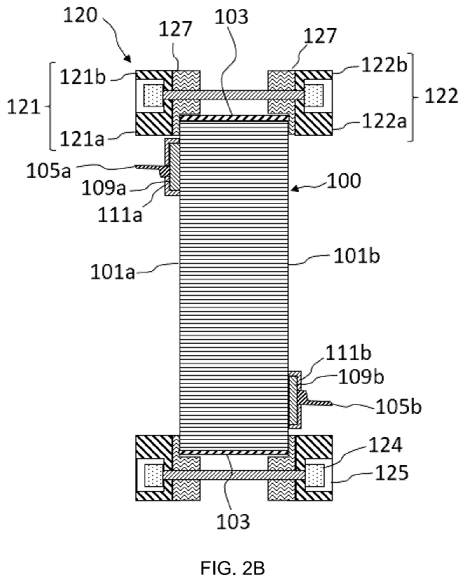

FIGS. 2A and 2B show an example of a heater element assembly including a frame 120 that clamps the heater element 100 from the side of the first end surface 101a and the side of the second end surface 101b.

The frame 120 has a first frame portion 121 and a second frame portion 122 for clamping the heater element from the first end surface 101a side and the second end surface 101b side.

The first frame portion 121 is made of resin and disposed on the side of the first end surface 101a, and has a flange portion 121b disposed on the outer peripheral side of an outer peripheral contour C of the first end surface 101a, and a holding portion 121a disposed on the inner peripheral side of the outer peripheral contour C of the first end surface 101a to apply a pressure to at least a part of the outer peripheral portion of the first end surface 101a. Further, the second frame portion 122 is made of resin and disposed on the side of the second end surface 101b, and has a flange portion 122b disposed on the outer peripheral side of the outer peripheral contour C of the second end surface 101b, and a holding portion 122a disposed on the inner peripheral side of the outer peripheral contour C of the second end surface 101b to apply a pressure to at least a part of the outer peripheral portion of the second end surface 101b.

As used herein, assuming the coordinate value of the center of gravity O of the first end surface 101a (second end surface 101b) is 0, a coordinate axis is taken in the direction from the center of gravity O toward the outer peripheral contour C of the first end surface 101a (second end surface 101b), and the coordinate value on the outer peripheral contour C is assumed to be 1.00R. Then, the set of points located between 0.90R and 1.00R is defined as the outer peripheral portion of the first end surface 101a (second end surface 101b).

In one embodiment, the first frame portion 121 (second frame portion 122) has an annular outer shape. The specific shape and dimensions of the first frame portion 121 (second frame portion 122) may be designed in accordance with the shape and dimensions of the first end surface 101a (second end surface 101b) of the heater element 100.

The holding portion 121a (122a) may apply pressure to the first end surface 101a (second end surface 101b) on the inner peripheral side than the outer peripheral portion, but if the holding portion 121a (122a) is expanded, the flow of air into and out of the heater element 100 is likely to be obstructed. Therefore, it is preferable that the holding portion 121a (122a) applies pressure only to the outer peripheral portion of the first end surface 101a (second end surface 101b).

Further, from the viewpoint of not obstructing the flow of air into and out of the heater element 100, the area of the portion of the first end surface 101a (second end surface 101b) to which pressure is applied by the holding portion 121a (122a) is preferably 10% or less, more preferably 8% or less, even more preferably 5% or less, even more preferably 2% or less, even more preferably 1.8% or less, and even more preferably 1.6% or less, of the entire area of the first end surface 101a (second end surface 101b). In addition, from the viewpoint of improving the holding performance for the heater element 100, the area of the portion of the first end surface 101a (second end surface 101b) to which pressure is applied by the holding portion 121a (122a) is preferably 1% or more, more preferably 1.2% or more, and even more preferably 1.4% or more, of the entire area of the first end surface 101a (second end surface 101b). Therefore, the ratio of the area of the portion of the first end surface 101a (second end surface 101b) to which pressure is applied by the holding portion 121a (122a) to the entire area of the first end surface 101a (second end surface 101b) is, for example, 1% or more and 10% or less.

The upper limit of the width W of the holding portion 121a (122a) is preferably 7 mm or less, more preferably 5 mm or less, and even more preferably 4 mm or less, from the viewpoint of not obstructing the flow of gas into and out of the heater element 100. In addition, from the viewpoint of improving the holding performance for the heater element 100, the lower limit of the width W of the holding portion 121a (122a) is preferably 1 mm or more, more preferably 2 mm or more, and even more preferably 3 mm or more. Therefore, the range of the width W of the holding portion 121a (122a) can be, for example, 1 mm or more and 7 mm or less. Here, the width W of the holding portion 121a (122a) means the length of the holding portion 121a (122a) in the direction from the outer peripheral contour C of the first end surface 101a (second end surface 101b) toward the center of gravity O of the first end surface 101a (second end surface 101b).

The resin constituting at least one, preferably both, of the first frame portion 121 and the second frame portion 122, is desirable to have a certain degree of softness so that the heater element 100 is not easily damaged. Therefore, in one embodiment, it is preferable that the resin constituting at least one, preferably both, of the first frame portion 121 and the second frame portion 122, have the upper limit of Rockwell hardness measured in accordance with ASTM D785-2008 R15 of 150 HRR or less, more preferably 130 HRR or less, and even more preferably 120 HRR or less. In another embodiment, it is preferable that the resin constituting at least one, preferably both, of the first frame portion 121 and the second frame portion 122, has the upper limit of Rockwell hardness measured in accordance with ASTM D785-2008 R15 of 120 HRM or less, more preferably 100 HRM or less, and even more preferably 90 HRM or less. The resin constituting at least one, preferably both, of the first frame portion 121 and the second frame portion 122, may satisfy the conditions regarding the upper limit of either one of the Rockwell hardness HRR and HRM described above, and it is desirable to satisfy both conditions.

On the other hand, from the viewpoint of improving the retention performance for the heater element 100, it is desirable that the resin constituting at least one, preferably both, of the first frame portion 121 and the second frame portion 122, has a certain degree of hardness. Therefore, in one embodiment, it is preferable that resin constituting at least one, preferably both, of the first frame portion 121 and the second frame portion 122, has the lower limit of Rockwell hardness measured in accordance with ASTM D785-2008 R15 of 70 HRR or more, more preferably 80 HRR or more, and even more preferably 90 HRR or more. In another embodiment, it is preferable that the resin constituting at least one, preferably both, of the first frame portion 121 and the second frame portion 122, has a lower limit of Rockwell hardness measured in accordance with ASTM D785-2008 R15 of 40 HRM or more, is more preferably 50 HRM or more, and even more preferably 70 HRM or more. The resin constituting at least one, preferably both, of the first frame portion 121 and the second frame portion 122, may satisfy the conditions regarding the lower limit of either one of the Rockwell hardness HRR and HRM described above, and it is desirable to satisfy both conditions.

Therefore, in one embodiment, the resin constituting at least one, preferably both, of the first frame portion 121 and the second frame portion 122, has a range of Rockwell hardness measured in accordance with ASTM D785-2008 R15 of, for example, 70 HRR or more and 150 HRR or less. In another embodiment, the resin constituting at least one, preferably both, of the first frame portion 121 and the second frame portion 122, has a range of Rockwell hardness measured in accordance with ASTM D785-2008 R15 of, for example, 40 HRM or more and 120 HRM or less.

There are no particular restrictions on the type of resin that the first frame portion 121 and the second frame portion 122, but from the viewpoint of heat resistance and corrosion resistance, it is preferable that the resin constituting at least one, preferably both, of the first frame portion 121 and the second frame portion 122, contain one or both of polyetheretherketone (PEEK) and polybutylene terephthalate (PBT), and more preferably contain 80% by mass or more, yet more preferably 90% by mass or more, and may contain 100% by mass of polyether ether ketone (PEEK) and polybutylene terephthalate (PBT) in total.

It is desirable that the resin constituting the first frame portion 121 and the second frame portion 122 have heat resistance. Therefore, it is preferable that the resin constituting at least one, preferably both, of the first frame portion 121 and the second frame portion 122, has the lower limit of the deflection temperature under load measured in accordance with JIS K7191-1: 2015 of 145° C. or higher, more preferably 160° C. or higher, and even more preferably 180° C. or higher. Although the upper limit of the deflection temperature under load is not particularly set, from the viewpoint of availability, it is usually 300° C. or lower, and typically 250° C. or lower. Accordingly, the resin constituting at least one, preferably both, of the first frame portion 121 and the second frame portion 122 has a deflection temperature under load of, for example, 145° C. or higher and 300° C. or lower.

It is desirable for the resin constituting the first frame portion 121 and the second frame portion 122 to have a high melting point so as not to melt when heated. Accordingly, it is preferable that the resin constituting at least one, preferably both, of the first frame portion 121 and the second frame portion 122, has a lower limit of the melting point of preferably 250° C. or higher, more preferably 280° C. or higher, and even more preferably 300° C. or higher. The upper limit of the melting point is not particularly set, but from the viewpoint of availability, it is usually 400° C. or lower, typically 350° C. or lower. The resin constituting at least one, preferably both, of the first frame portion 121 and the second frame portion 122, has a melting point range of, for example, 250° C. or higher and 400° C. or lower.

As used herein, the melting point of a resin refers to the lowest temperature at which an endothermic peak due to melting is observed when TG-DTA (thermogravimetry-differential thermal analysis) measurement is performed.

It is desirable that the resin constituting the first frame portion 121 and the second frame portion 122 has a low thermal conductivity in order to reduce heat loss. Therefore, it is preferable that the resin constituting at least one, preferably both, of the first frame portion 121 and the second frame portion 122, has the upper limit of thermal conductivity at 25° C. measured in accordance with JIS R1611: 2010 of 0.5 W/m/K or less, more preferably 0.3 W/m/K or less, and even more preferably 0.2 W/m/K or less. The lower limit of thermal conductivity is not particularly set, but from the viewpoint of availability, it is usually 0.1 W/m/K or more, typically 0.15 W/m/K or more. Therefore, the resin constituting at least one, preferably both, of the first frame portion 121 and the second frame portion 122, has a thermal conductivity range of, for example, 0.1 W/m/K or more and 0.5 W/m/K or less.

The resin constituting the first frame portion 121 and the second frame portion 122 is preferably insulating in order to suppress short circuits. Therefore, it is preferable that the resin constituting at least one, preferably both, of the first frame portion 121 and the second frame portion 122, has the lower limit of the volume resistivity at 25° C. measured according to the bridge method of JIS C 2139: 2008 of 1.0×10¹⁶ Ω·cm or more, preferably 2.0×10¹⁶ Ω·cm or more, and more preferably 5.0×10¹⁶ Ω·cm or more. Although the upper limit of the volume resistivity is not particularly set, from the viewpoint of availability, it is usually 1.0×10¹⁸ Ω·cm or less, and typically 1.0×10¹⁷ Ω·cm or less. Therefore, the resin constituting at least one, preferably both, of the first frame portion 121 and the second frame portion 122, has the volume resistivity of, for example, 1.0×10¹⁶ Ω·cm or more and 1.0×10¹⁸ Ω·cm or less.

Although the holding portion 121a (122a) may apply pressure directly to the first end surface 101a (second end surface 101b), it is preferable to apply pressure indirectly via a cushioning material 127. The holding portion 121a (122a) indirectly applies pressure to the first end surface 101a (second end surface 101b) via the cushioning material 127, so that the first end surface 101a (second end surface 101b) is less likely to be damaged. Further, the cushioning material 127 can also deform following the thermal deformation of the heater element 100 to relieve thermal stress. Thereby, generation of cracks in the heater element 100 can be suppressed.

The lower limit of the thickness in the compression direction of the cushioning material 127 when compressed by receiving the pressure from the holding portion 121a (122a) is preferably be 0.5 mm or more, more preferably 1.0 mm or more, and even more preferably 2.0 mm or more, from the viewpoint of ensuring a deformation margin to obtain a sufficient cushioning effect. Since it is necessary to ensure the holding surface pressure of the heating element and to hold the heating element without destroying it, the upper limit of the thickness in the compression direction of the cushioning material 127 when compressed by receiving the pressure from the holding portion 121a (122a) is preferably 7.0 mm or less, more preferably 5.0 mm or less, and even more preferably 4.0 mm or less. Therefore, the range of the thickness in the compression direction of the cushioning material 127 when compressed by receiving the pressure from the holding portion 121a (122a) can be, for example, 0.5 mm or more and 7.0 mm or less.

The lower limit of the pressure that the cushioning material 127 receives from the holding portion 121a (122a) is preferably 0.002 MPa or more, more preferably 0.005 MPa or more. The upper limit of the pressure that the cushioning material 127 receives from the holding portion 121a (122a) is preferably 0.2 MPa or less, more preferably 0.1 MPa or less. Therefore, the pressure that the cushioning material 127 receives from the holding portion 121a (122a) is preferably, for example, 0.002 MPa to 0.2 MPa, and more preferably 0.005 MPa to 0.1 MPa. The pressure that the cushioning material 127 receives from the holding portion 121a (122a) is determined from the Young's modulus and displacement amount of the cushioning material 127.

The lower limit of the Young's modulus of the cushioning material 127 is preferably 0.05 MPa or more, more preferably 0.06 MPa or more, and even more preferably 0.1 MPa or more, from the viewpoint of ensuring the holding force for the honeycomb heater element. The upper limit of the Young's modulus of the cushioning material 127 is preferably 0.3 MPa or less, more preferably 0.25 MPa or less, and even more preferably 0.2 MPa or less, from the viewpoint of ensuring a deformation margin to obtain a sufficient cushioning effect. Therefore, the range of the Young's modulus of the cushioning material 127 can be, for example, 0.05 MPa or more and 0.3 MPa or less.

The Young's modulus of the cushioning material 127 is determined from the relationship between the surface pressure and thickness change (displacement amount) when the sheet-like cushioning material is compressed by gradually applying surface pressure.

There is no particular restriction on the type of material constituting the cushioning material 127, but from the viewpoint of ensuring sufficient deformation margin, it is preferable that it be made of rubber, and more preferably that it is made of rubber sponge. Sponge means a porous body. Rubber and rubber sponge may contain various rubbers such as natural rubber, styrene/butadiene rubber, butadiene rubber, chloroprene rubber, ethylene/propylene rubber, butyl rubber, fluoro-rubber, acrylonitrile/butadiene rubber, silicone rubber, isoprene rubber, urethane rubber, chlorosulfonated polyethylene, hydrogenated nitrile rubber, epichlorohydrin rubber, acrylic rubber, ethylene acrylic rubber, norbornene rubber. These may be contained singly or in a mixture of two or more. Among these, it is more preferable that the cushioning material 127 be made of silicone rubber sponge whose main component is silicone rubber (preferably 60% by mass or more, more preferably 80% by mass or more).

In one embodiment, the first frame portion 121 and the second frame portion 122 can be provided in a mutually separated state. In that case, the first frame portion 121 and the second frame portion 122 can be connected with a fastener 124. By connecting them with the fastener 124, there is an advantage that the pressure applied by the holding portion 121a (122a) to the first end surface 101a (second end surface 101b) can be easily adjusted. The fastener 124 can be fixed to the flange portion 121b (flange portion 122b). The fastener 124 includes, but is not limited to, a combination of bolts and nuts. A concave portion 125 for accommodating the fastener 124 may be provided on the first frame portion 121 and the second frame portion 122. By providing the concave portion 125 it becomes difficult for the fastener 124 to fall off accidentally. The number and position of the locations where the first frame portion 121 and the second frame portion 122 are connected by the fastener 124 may be set as appropriate such that the heater element 100 can be stably held, but for example, it is preferable to set 4 to 8 locations at equal intervals in the peripheral direction of the flange portion 121b (flange portion 122b) (see FIG. 2A).

When the first frame portion 121 and the second frame portion 122 are separated from each other, other methods for connecting them include, but are not limited to, a method of connecting them using a fitting structure, and a method of connecting them using an adhesive.

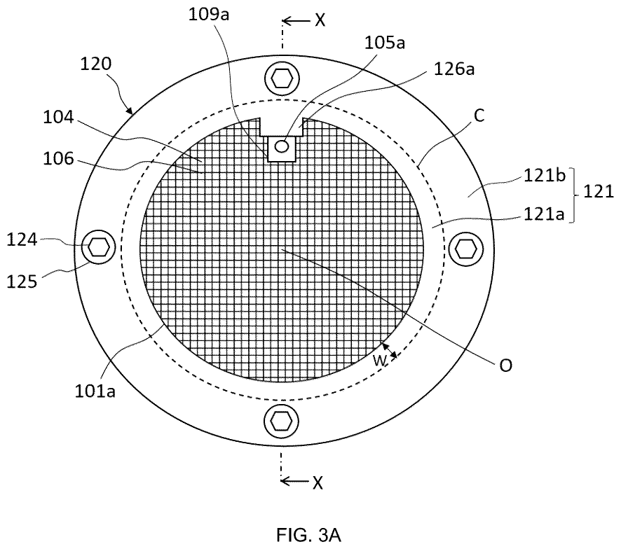

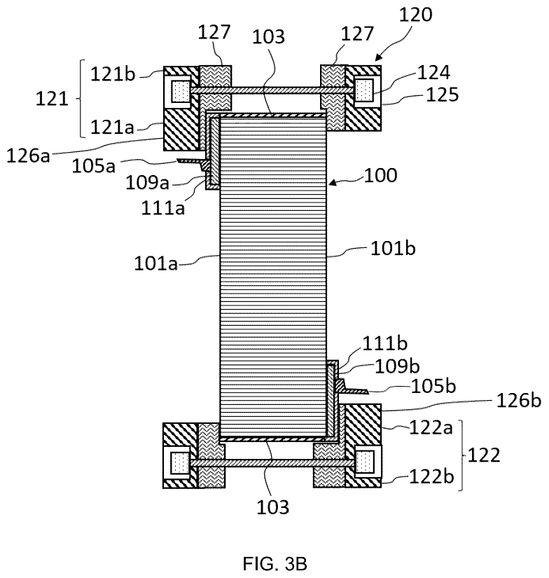

FIGS. 3A and 3B show another example of a heater element assembly including a frame 120 that clamps the heater element 100 from the side of the first end surface 101a and the side of the second end surface 101b. The holding portion 121a of the first frame portion 121 of the frame 120 shown in FIGS. 3A and 3B has a portion that presses the first terminal 109a toward the first end surface 101a. Similarly, the holding portion 122a of the second frame portion 122 of the frame 120 shown in FIGS. 3A and 3B has a portion that presses the second terminal 109b toward the second end surface 101b.

Since the holding portion 121a (holding portion 122a) has a portion that presses the first terminal 109a (second terminal 109b) toward the first end surface 101a (second end surface 101b), the first terminal 109a (second terminal 109b) can be effectively prevented from falling off. Further, there is also an advantage that the conduction characteristics between the first terminal 109a (second terminal 109b) and the first electrode layer 102a (second electrode layer 102b) are improved.

In order to enhance the effect of preventing the first terminal 109a from falling off, it is preferable that the holding portion 121a of the first frame portion 121 has a portion 126a that locally protrudes toward the inner peripheral side, and this protruding portion 126a constitutes at least a part of the portion that presses the first terminal 109a toward the first end surface 101a. Similarly, in order to enhance the effect of preventing the second terminal 109b from falling off, it is preferable that the holding portion 122a of the second frame portion 122 has a portion 126b that locally protrudes toward the inner peripheral side, and this protruding portion 126b constitutes at least a part of the portion that presses second first terminal 109b toward the second end surface 101b.

Since the holding portion 121a (holding portion 122a) only locally protrudes toward the inner peripheral side, it is possible to reduce the area that blocks the openings of the cells 104. When the portion 126a (126b) that locally protrudes toward the inner peripheral side for pressing the first terminal 109a (second terminal 109b) toward the first end surface 101a (second end surface 101b) is observed from the side of the first end surface 101a (second end surface 101b) (see FIG. 3A), the upper limit of the ratio of the area of the portion 126a (126b) locally protruding toward the inner peripheral side (if there is a plurality of portions 126a (126b) that locally protrude toward the inner peripheral side, it refers to their total area.) to the area of the first end surface 101a (second end surface 101b) is preferably 10% or less, more preferably 5% or less, and even more preferably 3% or less. On the other hand, from the viewpoint of increasing the effect of preventing the first terminal 109a (second terminal 109b) from falling off, it is preferable that the lower limit of the ratio of the area of the portion 126a (126b) locally protruding toward the inner peripheral side to the area of the first end surface 101a (second end surface 101b) be 0.5% or more, more preferably 1% or more, and even more preferably 2% or more. Therefore, the range of the ratio of the area of the portion 126a (126b) locally protruding toward the inner peripheral side to the area of the first end surface 101a (second end surface 101b) can be, for example, 0.5% or more and 10% or less.

In addition, in the heater element assembly in FIGS. 3A and 3B, the components designated by the same reference numerals as in FIGS. 2A and 2B are the same as described with respect to the heater element assembly in FIGS. 2A and 2B, and therefore explanation is omitted.

### (2-2. Heater Element Assembly Comprising an Outer Peripheral Surface Holding Type Frame)

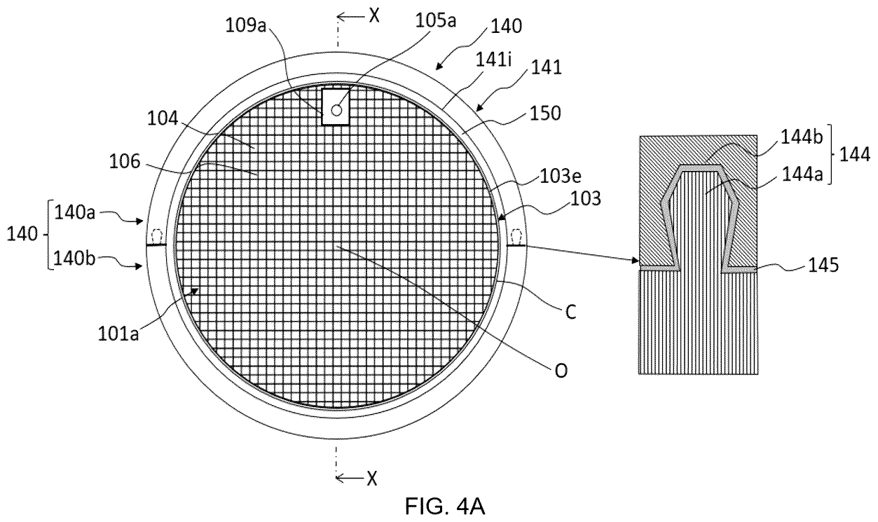

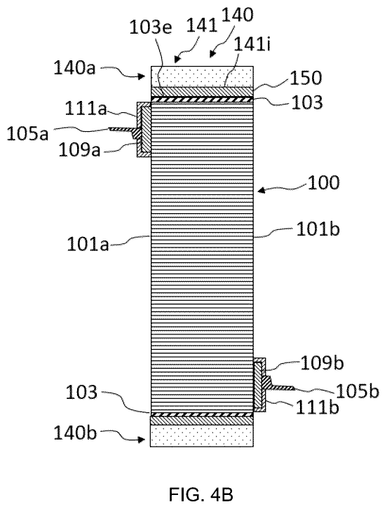

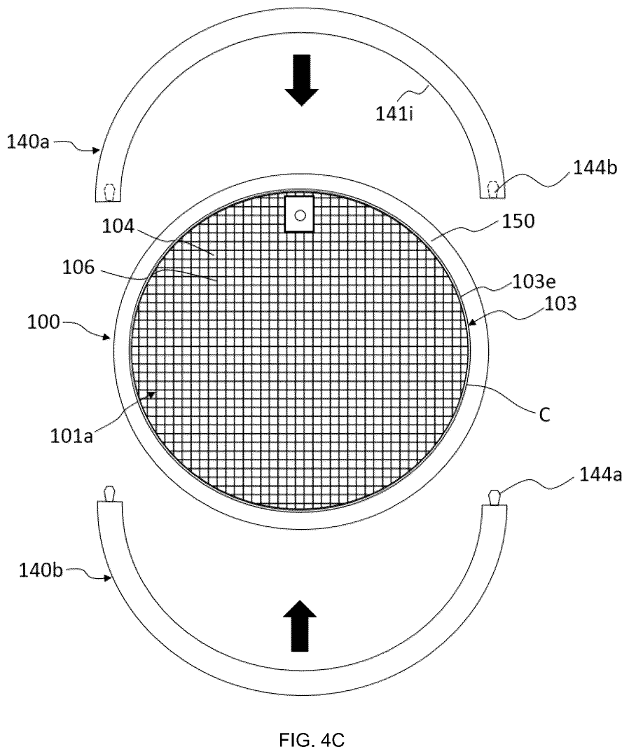

FIGS. 4A and 4B show an example of a heater element assembly comprising a frame 140 that holds the heater element 100 from the outer peripheral surface side of the outer peripheral wall 103. The frame 140 has a first frame portion 141 made of resin and having an inner peripheral surface 141i which fits with the outer peripheral surface 103e of the outer peripheral wall 103 of the honeycomb structure portion via a cushioning material 150. With this configuration, the frame 140 can hold the heater element 100 while suppressing damage to the honeycomb structure portion. In addition, the Cushioning material 150 can also deform in response to the thermal deformation of the heater element 100, thereby relieving thermal stress. This makes it possible to suppress the occurrence of cracks in the heater element 100.

From the viewpoint of stably holding the heater element 100 and enhancing the protective performance for the heater element 100, it is preferable that the frame 140 have a first frame portion 141 made of resin having an inner peripheral surface 141i that fits with the entire outer peripheral surface 103e of the outer wall 103 of the honeycomb structure portion via the cushioning material 150.

In one embodiment, the frame 140 shown in FIGS. 4A and 4B may be provided as a single, cylindrical piece. Alternatively, the frame 140 may be formed by joining two separate pieces together. When the frame 140 is divided into two pieces, methods for joining these two together include, but are not limited to, connecting these two together using fasteners, connecting them using a fitting structure, and connecting them using an adhesive.

The frame 140 shown in FIGS. 4A and 4B may be formed by connecting a pair of half-split members 140a, 140b in a direction perpendicular to the extension direction of the flow paths of the honeycomb structure portion. FIG. 4C shows a pair of half-split members 140a, 140b sandwiching the heater element 100 and approaching each other from a direction perpendicular to the direction in which the flow paths of the honeycomb structure portion extend.

The schematic enlarged partial cross-sectional view of FIG. 4A shows a pair of half-split members 140a, 140b connected by a connecting portion 144 having a fitting structure. The illustrated connecting portion 144 has a press-fit type convex portion 144a and a concave portion 144b. When the convex portion 144a is pushed into the concave portion 144b while being elastically deformed, the connected state is maintained by the restoring force of the convex portion 144a and the concave portion 144b. The connecting portion 144 may have a fitting structure other than the press-fit type, such as a snap-fit type. It is preferable to sandwich the cushioning material 145 between the pair of half-split members 140a, 140b. The cushioning material 145 compressed by being sandwiched between these two acts as a spring due to elastic deformation, and can prevent loosening of the connection between the pair of half-split members 140a, 140b.

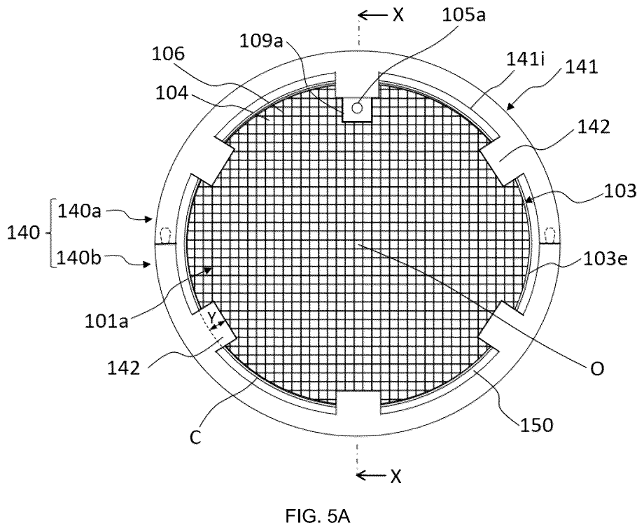

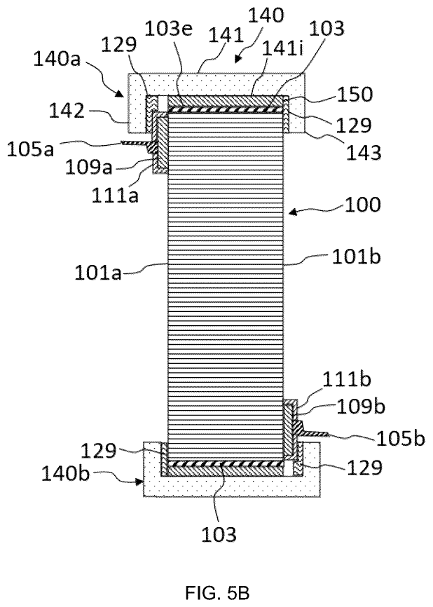

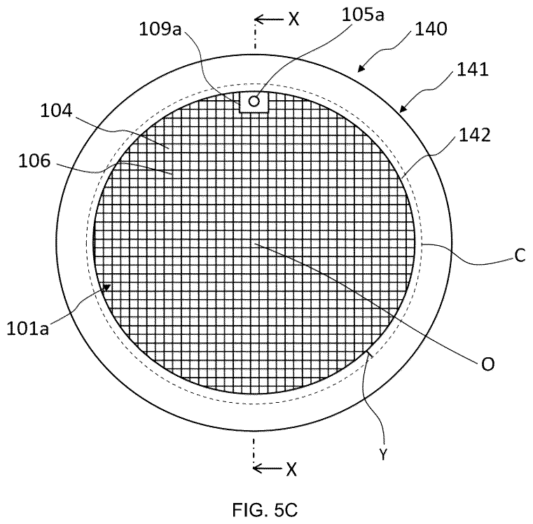

FIGS. 5A and 5B show another example of a heater element assembly comprising a frame 140 that holds the heater element 100 from the outer peripheral surface side of the outer peripheral wall 103. The frame 140 shown in FIGS. 5A and 5B is different from the frame 140 shown in FIGS. 4A and 4B in that it further includes, in addition to the first frame portion 141, a second frame portion 142 that extends toward the inner peripheral side from the outer peripheral contour C of the first end surface 101a and surrounds at least a part of the outer peripheral portion of the first end surface 101a, and a third frame portion 143 that extends toward the inner peripheral side from the outer peripheral contour C of the second end surface 101b and surrounds at least a part of the outer peripheral portion of the second end surface 101b. The second frame portion 142 and the third frame portion 143 may be extended from the first frame portion 141. The second frame portion 142 and the third frame portion 143 can also function as baffles to prevent bypass flow of gas from occurring in the areas where the cushioning material 150 is omitted when the cushioning material 150 is partially omitted due to the presence of corners in the heater element 100, for example.

When the frame 140 has the second frame portion 142 and the third frame portion 143, an effect of preventing the heater element 100 from moving in the direction in which the flow paths extend from the frame 140 and becoming detached is obtained. The second frame portion 142 (the third frame portion 143) does not have to contact the surface on the first end surface 101a (the second end surface 101b) side of the heater element 100, but it is preferable that the second frame portion 142 (the third frame portion 143) have a portion that presses the first terminal 109a (the second terminal 109b) toward the first end surface 101a (the second end surface 101b). In that case, the second frame portion 142 (the third frame portion 143) may be configured to press the first terminal 109a (the second terminal 109b) toward the first end surface 101a (the second end surface 101b) via the cushioning material 129.

The second frame portion 142 (the third frame portion 143) may partially surround the outer periphery of the first end surface 101a (the second end surface 101b) by locally protruding toward the inner peripheral side at one or more locations, as shown in FIG. 5A. When the second frame portion 142 (the third frame portion 143) is installed in a plurality of locations so as to locally protrude toward the inner peripheral side, it is preferable to install them at 4 to 8 locations at equal intervals in the circumferential direction of the first end surface 101a (the second end surface 101b) when the heater element assembly is viewed from the first end surface 101a (the second end surface 101b) side and/or point-symmetrically with the center of gravity O as the center of symmetry (see FIG. 5A). Alternatively, the second frame portion 142 (the third frame portion 143) may surround the entire outer peripheral portion of the first end surface 101a (the second end surface 101b) as shown in FIG. 5C.

The greater the area ratio of the portion pressed by the second frame portion 142 (the third frame portion 143) toward the first end surface 101a (the second end surface 101b) to the outer surface of the first terminal 109a (the second terminal 109b) is, the greater the effect of preventing the first end surface 101a (the second end surface 101b) from falling off is. For this reason, the lower limit of the area ratio is preferably 10% or more, more preferably 15% or more, and even more preferably 20% or more. On the other hand, the smaller the area ratio is, the easier it is to ensure space for the current-carrying component, making it easier to join the current-carrying component 105a (105b). For this reason, the upper limit of the area ratio is preferably 80% or less, more preferably 75% or less, and even more preferably 70% or less. Therefore, the range of the area ratio can be, for example, 10 to 80%.

The upper limit of the width Y of the region where the second frame portion 142 (the third frame portion 143) surrounds the first end surface 101a (the second end surface 101b) is preferably 10 mm or less, more preferably 7 mm or less, and even more preferably 5 mm or less, from the viewpoint of not interfering with the flow of gas entering and exiting the heater element 100. In addition, the lower limit of the width Y of the region where the second frame portion 142 (the third frame portion 143) surrounds the first end surface 101a (the second end surface 101b) is preferably 1 mm or more, more preferably 2 mm or more, and even more preferably 3 mm or more, from the viewpoint of improving the holding performance for the heater element 100. Therefore, the width Y of the region where the second frame portion 142 (the third frame portion 143) surrounds the first end surface 101a (the second end surface 101b) can be in the range of, for example, 1 mm or more and 10 mm or less. Here, the width Y of the region in which the second frame portion 142 (the third frame portion 143) surrounds the first end surface 101a (the second end surface 101b) means the length of the second frame portion 142 (the third frame portion 143) in the direction from the outer peripheral contour C of the first end surface 101a (the second end surface 101b) toward the center of gravity O of the first end surface 101a (the second end surface 101b).

When the second frame portion 142 (the third frame portion 143) is observed from the first end surface 101a (the second end surface 101b) side (see FIG. 5A), the upper limit of the ratio of the area of the second frame portion 142 (the third frame portion 143) (if there is a plurality of second frame portions 142 (third frame portions 143), this refers to their total area) to the area of the first end surface 101a (the second end surface 101b) is preferably 10% or less, more preferably 5% or less, and even more preferably 3% or less, from the viewpoint of not impeding the flow of gas entering and exiting the heater element 100. On the other hand, from the viewpoint of improving the holding performance for the heater element 100, the lower limit of the ratio of the area of the second frame portion 142 (the third frame portion 143) to the area of the first end surface 101a (the second end surface 101b) is preferably 0.5% or more, more preferably 1% or more, and even more preferably 2% or more. Therefore, the range of the ratio of the area of the second frame portion 142 (the third frame portion 143) to the area of the first end surface 101a (the second end surface 101b) can be, for example, 0.5% or more and 10% or less.

The frame 140 shown in FIGS. 5A and 5B is preferably formed by joining two separate pieces together. This is because, since the frame body 140 has the second frame portion 142 and the third frame portion 143, the operation of housing the heater element 100 in the frame body 140 can be made easier. When the frame body 140 is divided into two pieces, methods for joining these two together include, but are not limited to, connecting these two together using fasteners, connecting them using a fitting structure, and connecting them using an adhesive. The frame 140 shown in FIGS. 5A and 5B is formed by connecting a pair of half-split members 140a, 140b in a direction perpendicular to the extension direction of the flow paths of the honeycomb structure portion. A specific example of the fitting structure is shown in FIG. 4A.

It is desirable that the resin constituting the first frame portion 141, and preferably the resin constituting the second frame portion 142 and the third frame portion 143 in addition to the first frame portion 141, has a certain degree of softness such that the heater element 100 is less likely to be damaged. Therefore, in one embodiment, the resin constituting the first frame portion 141, and preferably the resin constituting the second frame portion 142 and the third frame portion 143 in addition to the first frame portion 141, preferably has the upper limit of Rockwell hardness measured in accordance with ASTM D785-2008 R15 of 150 HRR or less, more preferably 140 HRR or less, and even more preferably 130 HRR or less. In another embodiment, the resin constituting the first frame portion 141, and preferably the resin constituting the second frame portion 142 and the third frame portion 143 in addition to the first frame portion 141, preferably has the upper limit of Rockwell hardness measured in accordance with ASTM D785-2008 R15 of 120 HRM or less, more preferably 110 HRM or less, and even more preferably 100 HRM or less. The resin constituting the first frame portion 141, and preferably the resin constituting the second frame portion 142 and the third frame portion 143 in addition to the first frame portion 141, can satisfy the condition regarding the upper limit of either one of the Rockwell hardness HRR and HRM described above, and it is desirable to satisfy both conditions.

On the other hand, from the viewpoint of improving the holding performance for the heater element 100, it is desirable that the resin constituting the first frame portion 141, and preferably the resin constituting the second frame portion 142 and the third frame portion 143 in addition to the first frame portion 141, has a certain degree of hardness. Therefore, in one embodiment, the resin constituting the first frame portion 141, and preferably the resin constituting the second frame portion 142 and the third frame portion 143 in addition to the first frame portion 141, preferably has the lower limit of Rockwell hardness measured in accordance with ASTM D785-2008 R15 of 70 HRR or more, more preferably 80 HRR or more, and even more preferably 85 HRR or more. In another embodiment, the resin constituting the first frame portion 141, and preferably the resin constituting the second frame portion 142 and the third frame portion 143 in addition to the first frame portion 141, preferably has the lower limit of Rockwell hardness measured in accordance with ASTM D785-2008 R15 of 70 HRM or more, more preferably 80 HRM or more, and even more preferably 85 HRM or more. The resin constituting the first frame portion 141, and preferably the resin constituting the second frame portion 142 and the third frame portion 143 in addition to the first frame portion 141, can satisfy the condition regarding the lower limit value of either one of the Rockwell hardness HRR and HRM described above, and it is desirable to satisfy both conditions.

Therefore, in one embodiment, the resin constituting the first frame portion 141, and preferably the resin constituting the second frame portion 142 and the third frame portion 143 in addition to the first frame portion 141, has a Rockwell hardness range, for example, of 70 HRR or more and 150 HRR or less, measured in accordance with ASTM D785-2008 R15. In another embodiment, the resin constituting the first frame portion 141, preferably the resin constituting the second frame portion 142 and the third frame portion 143 in addition to the first frame portion 141, has a Rockwell hardness range, for example, of 70 HRM or more and 120 HRM or less, measured in accordance with ASTM D785-2008 R15.

There are no particular limitations on the type of resin constituting the first frame portion 141, the second frame portion 142, and the third frame portion 143. However, from the viewpoint of heat resistance and corrosion resistance, it is preferable that the first frame portion 141, and preferably the second frame portion 142 and the third frame portion 143 in addition to the first frame portion 141, contain one or both of polyether ether ketone (PEEK) and polybutylene terephthalate (PBT), and preferably contain 80% by mass or more, even more preferably 90% by mass or more, and may contain 100% by mass of polyether ether ketone (PEEK) and polybutylene terephthalate (PBT) in total.

It is desirable that the resin constituting the first frame portion 141, and preferably the resin constituting the second frame portion 142 and the third frame portion 143 in addition to the first frame portion 141, have heat resistance. Therefore, the first frame portion 141, and preferably the second frame portion 142 and the third frame portion 143 in addition to the first frame portion 141, preferably have the lower limit of a deflection temperature under load measured in accordance with JIS K7191-1:2015 of 145° C. or higher, more preferably 160° C. or higher, and even more preferably 180° C. or higher. Although the upper limit of the deflection temperature under load is not particularly set, from the viewpoint of availability, it is usually 300° C. or lower, typically 250° C. or lower. Therefore, the deflection temperature under load of the resin constituting the first frame portion 141, and preferably the resin constituting the second frame portion 142 and the third frame portion 143 in addition to the first frame portion 141, is in the range of 145° C. or higher and 300° C. or lower.

It is desirable for the resin constituting the first frame 141, and preferably the resin constituting the first frame 141 as well as the second frame 142 and the third frame 143, to have a high melting point so as not to melt when heated. Therefore, it is preferable that the lower limit of the melting point of the first frame portion 141, and preferably the first frame portion 141 as well as the second frame portion 142 and the third frame portion 143, is 250° C. or higher, more preferably 280° C. or higher, and even more preferably 300° C. or higher. There is no particular upper limit to the melting point, but from the viewpoint of availability, it is usually 400° C. or lower, typically 350° C. or lower. Therefore, the melting point of the resin constituting the first frame portion 141, and preferably the resin constituting the second frame portion 142 and the third frame portion 143 in addition to the first frame portion 141, is in the range of 250° C. or higher and 400° C. or lower.

As used herein, the melting point of a resin refers to the lowest temperature at which an endothermic peak due to melting is observed when TG-DTA (thermogravimetry-differential thermal analysis) measurement is performed.

It is desirable that the resin constituting the first frame portion 141, and preferably the resin constituting the second frame portion 142 and the third frame portion 143 in addition to the first frame portion 141, has low thermal conductivity in order to reduce heat loss. Therefore, the first frame portion 141, and preferably the second frame portion 142 and the third frame portion 143 in addition to the first frame portion 141, preferably have the upper limit of thermal conductivity at 25° C. measured in accordance with JIS R1611: 2010 of 0.5 W/m/K or less, more preferably 0.3 W/m/K or less, and even more preferably 0.2 W/m/K or less. Although the lower limit of the thermal conductivity is not particularly set, from the viewpoint of availability, it is usually 0.1 W/m/K or more, typically 0.15 W/m/K or more. Therefore, the thermal conductivity of the resin constituting the first frame portion 141, and preferably the resin constituting the second frame portion 142 and the third frame portion 143 in addition to the first frame portion 141, is in the range of 0.1 W/m/K or more and 0.5 W/m/K or less, for example.

The resin constituting the first frame portion 141, and preferably the resin constituting the second frame 142 and the third frame 143 in addition to the first frame 141, is preferably insulating in order to prevent short circuits. Therefore, the first frame portion 141, and preferably the second frame 142 and the third frame 143 in addition to the first frame 141, preferably have the lower limit of volume resistivity at 25° C. measured in accordance with the bridge method of JIS C2139: 2008 of 1.0×10¹⁶ Ω·cm or more, preferably 2.0×10¹⁶ Ω·cm or more, and more preferably 2.5×10¹⁶ Ω·cm or more. Although the upper limit of the volume resistivity is not particularly set, from the viewpoint of availability, it is usually 1.0×10¹⁷ Ω·cm or less, and typically 0.5×10¹⁷ Ω·cm or less. Therefore, the volume resistivity of the resin constituting the first frame 141, and preferably the resin constituting the second frame 142 and the third frame 143 in addition to the first frame 141, is in the range of 1.0×10¹⁶ Ω·cm or more and 1.0×10¹⁷ Ω·cm or less.

The lower limit of the thickness in the compression direction of the cushioning material 150 compressed by being sandwiched between the inner peripheral surface 141i of the first frame portion 141 and the outer peripheral surface 103e of the outer wall 103 of the honeycomb structure portion is preferably 0.5 mm or more, more preferably 1.0 mm or more, and even more preferably 2.0 mm or more, from the viewpoint of ensuring deformation allowance so as to exert a cushioning effect. The upper limit of the thickness in the compression direction of the cushioning material 150 compressed by being sandwiched between the inner peripheral surface 141i of the first frame portion 141 and the outer peripheral surface 103e of the outer wall 103 of the honeycomb structure portion preferably not 7.0 mm or less, more preferably than 5.0 mm or less, and even more preferably than 4.0 mm or less, from the viewpoint of compactification and reducing the space required for installation. Therefore, the range of thickness in the compression direction of the cushioning material 150 compressed by being sandwiched between the inner peripheral surface 141i of the first frame portion 141 and the outer peripheral surface 103e of the outer wall 103 of the honeycomb structure portion can be, for example, 0.5 mm or more and 7.0 mm or less.

From the viewpoint of ensuring a deformation allowance so as to exert a cushioning effect, the thickness in the compression direction of the cushioning material 129 compressed by receiving the pressure from the second frame portion 142 (the third frame portion 143) is preferably 0.5 mm or more, more preferably 1.0 mm or more, and even more preferably 2.0 mm or more. From the viewpoint of compactness and reducing the space required for installation, the thickness in the compression direction of the cushioning material 129 compressed by receiving the pressure from the second frame portion 142 (the third frame portion 143) is preferably 7.0 mm or less, more preferably 5.0 mm or less, and even more preferably 4.0 mm or less. Therefore, the range of thickness in the compression direction of the cushioning material 129 compressed by receiving the pressure from the second frame portion 142 (the third frame portion 143) can be, for example, 0.5 mm or more and 7.0 mm or less.

From the viewpoint of ensuring the holding force against the honeycomb heater element, the lower limit of the Young's modulus of the Cushioning material 150 and the Cushioning material 129 is preferably 0.05 MPa or more, more preferably 0.06 MPa or more, and even more preferably 0.07 MPa or more. From the viewpoint of ensuring a deformation allowance for exerting a cushioning effect, the upper limit of the Young's modulus of the cushioning material 150 and the cushioning material 129 is preferably 0.3 MPa or less, more preferably 0.25 MPa or less, and even more preferably 0.2 MPa or less. Therefore, the Young's modulus of the Cushioning material 150 and the Cushioning material 129 can be set in the range of, for example, 0.05 MPa or more and 0.3 MPa or less.

The Young's modulus of the cushioning material 150 and the cushioning material 129 is obtained from the relationship between surface pressure and thickness change when a sheet-like cushioning material is compressed by gradually applying surface pressure.

There are no particular limitations on the type of material that constitutes the cushioning material 150 and the cushioning material 129, but from the standpoint of ensuring sufficient deformation, it is preferably made of rubber, and more preferably made of rubber sponge. As the rubber and rubber sponge, contain various rubbers such as natural rubber, styrene-butadiene rubber, butadiene rubber, chloroprene rubber, ethylene-propylene rubber, butyl rubber, fluoro-rubber, acrylonitrile-butadiene rubber, silicone rubber, isoprene rubber, urethane rubber, chlorosulfonated polyethylene, hydrogenated nitrile rubber, epichlorohydrin rubber, acrylic rubber, ethylene acrylic rubber, and norbornene rubber can be contained, and these may be contained alone or in combination of two or more. Among these, it is more preferable that the cushioning material 150 be made of a silicone rubber sponge containing silicone rubber as a main component (preferably 60% by mass or more, and more preferably 80% by mass or more).

From the viewpoint of ensuring cushioning properties, the thickness in the compression direction of the cushioning material 145 compressed by being sandwiched between a pair of half-split members 140a, 140b is preferably 0.1 mm or more, more preferably 0.2 mm or more, and even more preferably 0.5 mm or more. From the viewpoint of ensuring rigidity, the upper limit of the thickness in the compression direction of the compressed cushioning material 145 is preferably 3 mm or less, more preferably 2 mm or less, and even more preferably 1 mm or less. Therefore, the range of thickness in the compression direction of the compressed cushioning material 145 can be, for example, 0.1 mm or more and 3 mm or less.

From the viewpoint of ensuring the rigidity of the structure, the lower limit of the Young's modulus of the Cushioning material 145 is preferably 0.05 MPa or more, more preferably 0.08 MPa or more, and even more preferably 0.1 MPa or more. From the viewpoint of ensuring the cushioning function, the upper limit of the Young's modulus of the cushioning material 145 is preferably 0.3 MPa or less, more preferably 0.2 MPa or less, and even more preferably 0.15 MPa or less. Therefore, the Young's modulus of the Cushioning material 145 can be set in the range of, for example, 0.05 MPa or more and 0.3 MPa or less.

The method for measuring the Young's modulus of the Cushioning material 145 is as described in the description of the Cushioning material 150.

The materials constituting the cushioning material 145 are as described in the description of the cushioning material 150, including the preferred embodiment.

### (3. Manufacturing Method of Heater Element)

Next, a method for manufacturing a heater element according to the present invention will be exemplified.

The method for manufacturing the honeycomb structure portion that constitutes the heater element includes a forming process and a firing process.

In the forming step, a green body containing ceramic raw materials including BaCO₃ powder, TiO₂ powder, and rare earth nitrate or hydroxide powder is formed to prepare a honeycomb formed body having a relative density of 60% or more.

The ceramic raw material can be obtained by dry mixing each powder to obtain a desired composition.

The green body can be obtained by adding a dispersion medium, a binder, a plasticizer, and a dispersant to the ceramic raw material and kneading the mixture. The green body may contain additives such as a shifter, a metal oxide, a property improving agent, and a conductive powder, if necessary.

The formulation amounts of components other than the ceramic raw material is not particularly limited as long as the relative density of the honeycomb formed body is 60% or more.

As used herein, the “relative density of the honeycomb formed body” means the ratio of the density of the honeycomb formed body to the true density of the entire ceramic raw material. Specifically, it can be determined by the following formula:

Relative density of honeycomb formed body (%)=Density of honeycomb formed body (g/cm³)/True density of entire ceramic raw material (g/cm³)×100

The density of the honeycomb formed body can be measured by the Archimedes method using pure water as a medium. Further, the true density of the entire ceramic raw material can be determined by dividing the total mass (g) of each raw material by the total volume (cm³) of each raw material.

As the dispersion medium, mention can be made to water or a mixed solvent of water and an organic solvent such as alcohol, and water is particularly preferably used.

As the binder, examples include organic binders such as methylcellulose, hydroxypropoxycellulose, hydroxyethylcellulose, carboxymethylcellulose, and polyvinyl alcohol. In particular, it is suitable to use methyl cellulose and hydroxypropoxy cellulose in combination. One type of binder may be used alone or two or more types may be used in combination, but it is preferable that the binder does not contain an alkali metal element.

As the plasticizer, examples include polyoxyalkylene alkyl ether, polycarboxylic acid polymer, and alkyl phosphate ester.

As the dispersant, surfactants such as polyoxyalkylene alkyl ether, ethylene glycol, dextrin, fatty acid soap, and polyalcohol can be used. As the dispersant, one type may be used alone, or two or more types may be used in combination.

The honeycomb formed body can be produced by extrusion molding the green body. For extrusion molding, a die having a desired overall shape, cell shape, partition wall thickness, cell density, and the like can be used.

The lower limit of the relative density of the honeycomb formed body obtained by extrusion molding is preferably 60% or more, more preferably 65% or more. By controlling the relative density of the honeycomb formed body within such a range, it becomes possible to make the honeycomb formed body dense and reduce the electrical resistance at room temperature. In addition, the upper limit of the relative density of the honeycomb formed body is not particularly limited, but is generally 80% or less, preferably 75% or less.

The honeycomb formed body can be dried before the firing process. The drying method is not particularly limited, and for example, conventionally known drying methods such as hot gas drying, microwave drying, dielectric drying, reduced pressure drying, vacuum drying, and freeze drying can be used. Among these, a drying method that combines hot gas drying with microwave drying or dielectric drying is preferred because the entire formed body can be dried quickly and uniformly.

The firing step includes holding the temperature at 1150 to 1250° C., then raising the temperature to a maximum temperature of 1360 to 1430° C. at a temperature rising rate of 20 to 600° C./hour, and holding the temperature for 0.5 to 10 hours.

By holding the honeycomb formed body at a maximum temperature of 1360 to 1430° C. for 0.5 to 10 hours, it is possible to obtain a honeycomb structure portion whose main component is BaTiO₃-based crystal particles in which a part of Ba is replaced with a rare earth element.

Further, by maintaining the temperature at 1150 to 1250° C., Ba₂TiO₄ crystal particles generated during the firing process are easily removed, so that the honeycomb structure portion can be made denser.

Furthermore, by increasing the temperature from 1150 to 1250° C. to the maximum temperature of 1360 to 1430° C. at a rate of 20 to 600° C./hour, 1.0 to 10.0% by mass of Ba₆Ti₁₇O₄₀ crystal particles are generated in the honeycomb structure portion.

The holding time at 1150 to 1250° C. is not particularly limited, but is preferably 0.5 to 10 hours. With such a holding time, Ba₂TiO₄ crystal particles generated during the firing process can be easily removed stably.

The firing step preferably includes holding the temperature at 900 to 950° C. for 0.5 to 5 hours. By holding the temperature at 900 to 950° C. for 0.5 to 5 hours, BaCO₃ is efficiently decomposed and a honeycomb structure portion having a predetermined composition is easily obtained.

In addition, a degreasing process for removing the binder may be performed before the firing process. The atmosphere in the degreasing step is preferably air in order to completely decompose the organic components.

Furthermore, the atmosphere in the firing step is preferably air from the viewpoint of controlling electrical characteristics and manufacturing cost.

The firing furnace used in the firing process and the degreasing process is not particularly limited, but an electric furnace, a gas furnace, and the like can be used.

By joining a pair of electrode layers (first electrode layer 102a and second electrode layer 102b) to the honeycomb structure portion obtained in this way, a heater element can be manufactured. The first electrode layer 102a and the second electrode layer 102b can be formed on the first end surface 101a and the second end surface 101b of the honeycomb structure portion by a metal deposition method such as sputtering, vapor deposition, electrolytic deposition, or chemical deposition. Further, the first electrode layer 102a and the second electrode layer 102b can also be formed by applying an electrode paste to the first end surface 101a and the second end surface 101b of the honeycomb structure portion and then baking the paste. Furthermore, they can also be formed by thermal spraying. The first electrode layer 102a and the second electrode layer 102b may be composed of a single layer, but may also be composed of a plurality of electrode layers having different compositions. When forming the first electrode layer 102a and the second electrode layer 102b on the end surfaces by the above method, if the thickness of the electrode layers is set so as not to become excessively large, cells can be prevented from being blocked.

Methods for forming the first electrode layer 102a and the second electrode layer 102b include, but are not limited to, baking of electrode paste, dry plating such as sputtering and vapor deposition, wet plating such as electrolytic deposition and chemical deposition, and joining metal plates or alloy plates. Each method has a suitable thickness range. The thickness can be approximately 5 to 30 μm for baking electrode paste, approximately 100 to 1000 nm for dry plating such as sputtering and vapor deposition, approximately 10 to 100 μm for thermal spraying, and approximately 5 to 30 μm for wet plating such as electrolytic deposition and chemical deposition. Further, when joining metal plates or alloy plates, the thickness of the electrode layer can be about 5 to 100 μm.

Next, a first terminal 109a is connected to the outer surface of the first electrode layer 102a, and a second terminal 109b is connected to the outer surface of the second electrode layer 102b. As described above, methods for connecting these two include welding, brazing, mechanical contact, and the like. Further, when baking the electrode paste for forming the first electrode layer 102a (second electrode layer 102b), the first terminal 109a (second terminal 109b) may be connected by baking at the same time.

Next, as necessary, the current-carrying components 105a, 105b are connected to the first terminal 109a and the second terminal 109b, respectively. As described above, methods for connecting these two include welding, brazing, mechanical contact, and the like.

Next, the first moisture absorbent-containing layer 107a covering a part of the outer surface of the first electrode layer 102a and the second moisture absorbent-containing layer 107b covering a part of the outer surface of the second electrode layer 102b are formed. In a preferred embodiment, the third moisture absorbent-containing layer 111a covering a part of the outer surface of the first terminal 109a and a fourth moisture absorbent-containing layer 111b covering a part of the outer surface of the second terminal 109b are further formed. In a more preferred embodiment, the fifth moisture absorbent-containing layer 113 is further formed to cover a part or all of the surface of the partition walls 106 that form the flow paths inside the cells 104.

The first moisture absorbent-containing layer 107a, the second moisture absorbent-containing layer 107b, the third moisture absorbent-containing layer 111a, the fourth moisture absorbent-containing layer 111b, and the fifth moisture absorbent-containing layer 113 may be formed individually, or they can also be formed simultaneously. These moisture absorbent-containing layers can be formed simultaneously by, for example, the following steps. The heater element before forming the moisture absorbent-containing layers is immersed in a slurry containing the moisture absorbent, optionally a functional material other than the moisture absorbent, a binder, and a dispersion medium for a predetermined time, and excess slurry on the outer peripheral surface of the honeycomb structure portion is removed by blowing and wiping. Thereafter, these moisture absorbent-containing layers can be formed by drying the slurry. Drying can be carried out, for example, while heating a heater element to a temperature of about 120 to 600° C. The series of steps of dipping, slurry removal, and drying may be performed only once, but by repeating the steps multiple times, moisture absorbent-containing layers with a desired thickness can be provided on the surface of the electrode layer or the like.

Although an organic binder may be used as the binder, it is preferable to use an inorganic binder because there is a concern that smoke will be emitted by heat and components in the smoke will flow into the vehicle interior and deteriorate the vehicle interior environment. Suitable types of inorganic binder are as described above.

The dispersion medium can be water, an organic solvent (for example, toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether), or a mixture thereof.

### (4. Air Conditioning System)

According to one embodiment of the present invention, an air conditioning system is provided that includes the heater element described above. The air conditioning system can be used to improve the interior spaces of various vehicles such as automobiles, as well as buildings such as houses, offices, factories, stores, warehouses, and freezers, and means of transportation such as ships and airplanes.

### (4-1. First Air Conditioning System 1000)

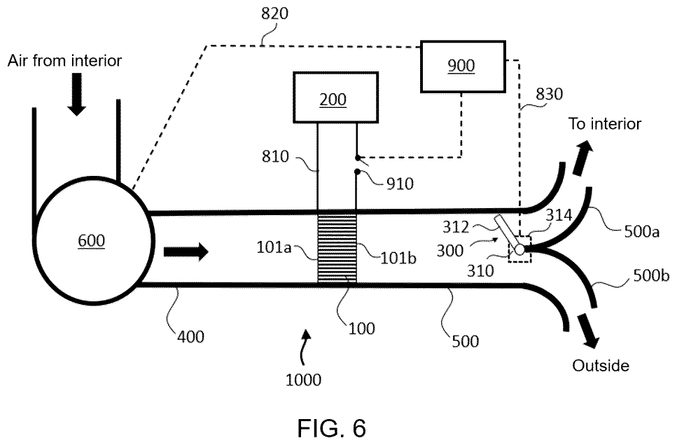

FIG. 6 is a schematic diagram showing the configuration of a first air conditioning system 1000 according to an embodiment of the present invention.

The first air conditioning system 1000 comprises:
at least one heater element 100;
a power source 200 such as a battery for applying voltage to the heater element 100;
an inflow pipe 400 that communicates an interior such as a vehicle interior with an inlet end surface of the heater element 100;
an outflow pipe 500 having a first route 500a that communicates the outlet end surface of the heater element 100 with the interior; and
a ventilator 600 for causing air from the interior to flow into the inlet end surface of the heater element 100 via the inflow pipe 400.

In the air conditioning system shown in FIG. 6, the heater element 100 is arranged such that its inlet end surface is the first end surface 101a and its outlet end surface is the second end surface 101b. However, the heater element 100 can also be arranged such that the inlet end surface is the second end surface 101b and the outlet end surface is the first end surface 101a. Although there may be one heater element 100, a plurality of heater elements 100 may be arranged in series or in parallel.

In addition to the first route 500a, the outflow pipe 500 can have a second route 500b that communicates the outlet end surface of the heater element 100 with the outside of the vehicle or the like. Further, the outflow pipe 500 can include a switching valve 300 that can switch the flow of air flowing through the outflow pipe 500 between the first route 500a and the second route 500b.

The first air conditioning system 1000 may have driving modes of:
a first mode in which the applied voltage from the power source 200 is turned off, the switching valve 300 is switched such that the air flowing through the outflow pipe 500 passes through the first route 500a, and the ventilator 600 is turned on; and
a second mode in which the applied voltage from the power source 200 is turned on, the switching valve 300 is switched such that the air flowing through the outflow pipe 500 passes through the second route 500b, and the ventilator 600 is turned on.

The first air conditioning system 1000 can include a controller 900 that can perform switching between the first mode and the second mode. For example, the controller 900 may be configured to be able to alternately execute the first mode and the second mode. By repeating switching between the first mode and the second mode in a constant cycle, it becomes possible to stably discharge components to be removed, such as indoor water vapor, to the outside of the vehicle.

In the first mode, the component to be removed in the air is removed. Specifically, air from the interior flows in from the inlet end surface of the heater element 100 through the inflow pipe 400, passes through the inside of the heater element 100, and then flows out from the outlet end surface of the heater element 100. The components to be removed from the air from the interior are captured by a functional material such as a dehumidifier while passing through the heater element 100, and thereby removed. The air from which the removal target has been removed flows out from the outlet end surface of the heater element 100 and is returned to the interior through the first route 500a of the outflow pipe 500. The air may also be supplied to other air conditioning systems (for example, HVAC of the vehicle).

In the second mode, functional materials such as a moisture absorbent are regenerated. Specifically, air from the interior flows in from the inlet end surface of the heater element 100 through the inflow pipe 400, passes through the inside of the heater element 100, and then flows out from the outlet end surface of the heater element 100. The heater element 100 generates heat when energized, thereby heating the functional material supported on the heater element 100, so that the component to be removed, which is captured by the functional material, separates from the functional material or reacts.

In order to promote desorption of the component to be removed that is captured by the functional material, it is preferable to heat the functional material to a temperature higher than the desorption temperature depending on the type of the functional material. When using a moisture absorbent as a functional material, it is preferable to heat at least a part, preferably all, of the moisture absorbent to 70 to 150° C., preferably heat to 80 to 140° C., and even more preferably heat to 90 to 130° C. Further, it is desirable that the second mode be carried out for a period of time until the functional material is sufficiently regenerated. Although it depends on the type of functional material, for example, when a moisture absorbent is used as the functional material, it is preferable that the functional material is heated to the above temperature range for 1 to 10 minutes in the second mode, and it is more preferably heated for 2 to 8 minutes, and it is even more preferably heated for 3 to 6 minutes.

In the second mode, the air from the interior flows out from the outlet end surface of the heater element 100 while entraining the components to be removed that have separated from the functional material while passing through the heater element 100. The air containing the component to be removed that flows out from the outlet end surface of the heater element 100 is discharged to the outside through the second path 500b of the outflow pipe 500.

Switching on and off the applied voltage to the heater element 100 is possible by, for example, electrically connecting the power source 200 and the pair of terminals 109a, 109b of the heater element 100 with an electric wire 810, and operating a power switch 910 provided on the way. The controller 900 may operate the power switch 910.

Switching on and off the ventilator 600 is possible by, for example, electrically connecting the controller 900 and the ventilator 600 by an electric wire 820 or wirelessly, and operating a switch (not shown) of the ventilator 600 by the controller 900. The ventilator 600 can also be configured such that the amount of ventilation can be changed by the controller 900.

The switching of the switching valve 300 is possible by, for example, electrically connecting the controller 900 and the switching valve 300 with an electric wire 830 or wirelessly, and operating a switch (not shown) of the switching valve 300 using the controller 900.

The switching valve 300 is not particularly limited as long as it is electrically driven and has the function of switching the flow paths, and examples thereof include a solenoid valve and an electric valve. In one embodiment, the switching valve 300 includes an opening/closing door 312 supported by a rotating shaft 310 and an actuator 314 such as a motor that rotates the rotating shaft 310. The actuator 314 is configured to be controllable by the controller 900.

In the first air conditioning system 1000, from the viewpoint of stably ensuring the above-mentioned functions, it is desirable that the heater element 100 be disposed at a position close to the vehicle interior. Therefore, from the viewpoint of preventing electric shock or the like, it is preferable that the driving voltage is 60 V or less. Since the honeycomb structure portion used in the heater element 100 has low electrical resistance at room temperature, it is possible to heat the honeycomb structure portion with this low driving voltage. In addition, the lower limit of the driving voltage is not particularly limited, but is preferably 10 V or more. If the drive voltage is less than 10V, the electric current when heating the honeycomb structure portion becomes large, so it is necessary to make the electric wire 810 thick. Therefore, the driving voltage of the first air conditioning system 1000 can be, for example, 10V or more and 60V or less.

In the embodiment shown in FIG. 6, the ventilator 600 is installed upstream of the heater element 100. More specifically, the ventilator 600 is installed on the way of the inflow pipe 400 that communicates the heater element 100 with the interior, and the air that has passed through the ventilator 600 flows in so as to be forced toward the heater element 100. Alternatively, the ventilator 600 may be placed downstream of the heater element 100. In this case, the ventilator 600 can be installed, for example, on the way of the outflow pipe 500, and the air that has passed through the inflow pipe 400 flows into the heater element 100 so as to be sucked into it.

### EXAMPLES

### [1. Specifications of Honeycomb Structure Portion]

Honeycomb structure portions with the following specifications were prepared.
Shape of the cross-section and end surface of the honeycomb structure portion orthogonal to the direction in which the flow paths extend: Quadrangle (curvature radius of 6 mm or more)
Cell opening shape orthogonal to the direction in which the flow paths extend: square with rounded corners
Thickness of the partition walls: 0.100 mm
Thickness of the outer peripheral wall: 0.3 mm
Cell density: 80 cells/cm²
Cell pitch: 1.11 mm
Cell opening ratio: 0.797
Size of cross-section orthogonal to the direction in which the flow paths of the honeycomb structure portion extend: 90 mm×90 mm
Length in the direction in which the flow paths of the honeycomb structure portion extend: 12 mm
Volume resistivity at 25° C. of the material constituting the outer peripheral wall and the partition walls: 15 Ω·cm
Curie point of the material constituting the outer peripheral wall and the partition walls: 120° C.
Material constituting the outer peripheral wall and the partition walls: Barium titanate
Density of the material constituting the outer peripheral wall and the partition walls: 5750 kg/m³
Specific heat of the material constituting the outer peripheral wall and the partition walls: 550 J/kg/K

### [2. Properties of Moisture Absorbent Used]

Commercially available amorphous aluminum silicate was prepared as a moisture absorbent. After drying at 180° C. for 2 hours or more, 5 g of amorphous aluminum silicate was left in a thermo-hygrostat kept at room temperature (25° C.) and 50% relative humidity for one hour. The mass (g) of water that can be adsorbed per 1 g of dry mass was determined from the increased mass of the amorphous aluminum silicate taken out from the thermo-hygrostat. The results are shown in Table 1.

After drying at 180° C. for 2 hours or more, 5 g of amorphous aluminum silicate was placed in a thermo-hygrostat kept at a relative humidity of 50%, and changes in mass were investigated after being left at various temperatures for 1 hour. In this way, the temperature range in which the mass (g) of water that can be adsorbed per gram of dry mass was 5 g/g or more was determined and the upper limit was determined as the moisture adsorption temperature. The results are shown in Table 1. In addition, the lower the temperature is, the greater the mass of water that can be adsorbed.

After drying at 180° C. for 2 hours or more, 5 g of amorphous aluminum silicate was left in a thermo-hygrostat kept at room temperature (25° C.) and 50% relative humidity for one hour to adsorb moisture. The amorphous aluminum silicate after water adsorption was placed in a thermo-hygrostat kept at a relative humidity of 50%, and the changes in mass were investigated when the amorphous aluminum silicate was left at various temperatures for 0.1 hour. The lowest temperature at which the mass reduction rate for amorphous aluminum silicate after water adsorption was 30% was defined as the water desorption temperature. The results are shown in Table 1.

### [3. Manufacture of Heater Element]

Heater elements according to the following Examples and Comparative Examples were manufactured in quantities necessary for various analyzes and tests.

### Example 1

A paste made by mixing aluminum powder with a binder resin was applied to both end surfaces (first end surface 101a and second end surface 101b) of the honeycomb structure portion and baked to form a pair of electrode layers (the first electrode layer 102a and the second electrode layer 102b) (see Table 1 for volume resistivity at 25° C.).

The ratio (coverage rate) of the area of the first end surface 101a (the second end surface 101b) covered by the first electrode layer 102a (the second electrode layer 102b) to the area of the first end surface 101a (the second end surface 101b) excluding the opening of the cells 104 (that is, the partition wall portions and outer peripheral wall portion) was calculated based on the both areas. The results are shown in Table 1. In addition, the average thickness of the first electrode layer 102a (the second electrode layer 102b) was measured by the above-mentioned measuring method. The results are shown in Table 1.

Next, a rectangular plate-shaped first terminal 109a and a second terminal 109b made of pure aluminum (A1050) (see Table 1 for volume resistivity at 25° C.) and having planar dimensions and thicknesses shown in Table 1 were connected by soldering to the outer surfaces of the first electrode layer 102a and the second electrode layer 102b but only to the outer peripheral portion of the first end surface 101a and the second end surface 101b, respectively. Next, electric wires serving as current-carrying components 105a, 105b were connected to the outer surfaces of the first terminal 109a and the second terminal 109b by soldering, respectively.

The ratio (coverage rate) of the area that the first terminal 109a (the second terminal 109b) covered the first end surface 101a (the second end surface 101b) to the area of the first end surface 101a (the second end surface 101b) was calculated based on the area of both. The results are shown in Table 1.

Next, a moisture absorbent slurry was prepared by mixing amorphous aluminum silicate powder, silica powder, and solvent (water) in a mass ratio of amorphous aluminum silicate:silica:solvent=95:5:100, and stirring. After applying the obtained moisture absorbent slurry to the outer surface of the first electrode layer 102a and the outer surface of the second electrode layer 102b by a brush coating method, by drying in a dryer at 190° C. for 2 hours, a first moisture absorbent-containing layer 107a and a second moisture absorbent-containing layer 107b were formed, thereby producing a heater element.

Of the outer surface of the first electrode layer 102a (the second electrode layer 102b), the ratio (coverage rate) of the area that the first moisture absorbent-containing layer 107a (the second moisture absorbent-containing layer 107b) covered the outer surface of the first electrode layer 102a (the second electrode layer 102b) to the area of the portion where the first terminal 109a (the second terminal 109b) was not connected were calculated based on the area of both. The results are shown in Table 1. Further, the average thickness of the first moisture absorbent-containing layer 107a (the second moisture absorbent-containing layer 107b) was measured by the above-mentioned measuring method. The results are shown in Table 1.

According to the procedure described above, electrical resistance measurements were performed at 12 locations on each of the first moisture absorbent-containing layer 107a and the second moisture absorbent-containing layer 107b. The electrical resistance range (minimum value to maximum value) at this time is shown in Table 1.

### Example 2

In the same manner as in Example 1, a pair of electrode layers (the first electrode layer 102a and the second electrode layer 102b) were bonded to both end surfaces of the honeycomb structure.

Next, the first terminal 109a and the second terminal 109b were connected to the outer surfaces of the first electrode layer 102a and the second electrode layer 102b, respectively, in the same manner as in Example 1. Next, the electric wires which are the current-carrying components 105a, 105b were connected to the outer surfaces of the first terminal 109a and the second terminal 109b, respectively, in the same manner as in Example 1.

Next, the same moisture absorbent slurry as in Example 1 was applied by brush coating to the outer surfaces of the first electrode layer 102a and the second electrode layer 102b, and the outer surfaces of the first terminal 109a and the second terminal 109b, and then dried at 190° C. for 2 hours in a dryer to form the first moisture absorbent-containing layer 107a and the second moisture absorbent-containing layer 107b, as well as the third moisture absorbent-containing layer 111a and the fourth moisture absorbent-containing layer 111b, thereby preparing a heater element.

The ratio (coverage rate) of the area that the first moisture layer 107b) covered the outer surface of the first electrode layer 102a (the second electrode layer 102b) to the area of the portion where the first terminal 109a (the second terminal 109b) was not connected among the outer surface of the first electrode layer 102a (the second electrode layer 102b) was calculated based on the both areas.

The ratio (coverage rate) of the area of the outer surface of the first terminal 109a (the second terminal 109b) covered by the third moisture absorbent-containing layer 111a (the fourth moisture absorbent-containing layer 111b) to the area of the portion where the current-carrying component 105a was not connected among the outer surface of the first terminal 109a (the second terminal 109b) was calculated based on the both areas.

Further, the average thickness of the first moisture absorbent-containing layer 107a (the second moisture absorbent-containing layer 107b) and the average thickness of the third moisture absorbent-containing layer 111a (the fourth moisture absorbent-containing layer 111b) were measured by the above-mentioned measuring procedure.

The results are shown in Table 1.

According to the procedure described above, electrical resistance measurements were performed at 12 locations on each of the first moisture absorbent-containing layer 107a and the second moisture absorbent-containing layer 107b. The electrical resistance range (minimum value to maximum value) at this time is shown in Table 1.

According to the procedure described above, electrical resistance measurements were performed at 5 locations between two arbitrary points spaced 3 mm apart on the outer surfaces of the third moisture absorbent-containing layer 111a and the fourth moisture absorbent-containing layer 111b at 25° C. The range of electrical resistance (minimum value to maximum value) is shown in Table 1.

### Example 3

In the same manner as in Example 1, a pair of electrode layers (the first electrode layer 102a and the second electrode layer 102b) were bonded to both end surfaces of the honeycomb structure.

Next, the first terminal 109a and the second terminal 109b were connected to the outer surfaces of the first electrode layer 102a and the second electrode layer 102b, respectively, in the same manner as in Example 1. Next, the electric wires which are the current-carrying components 105a, 105b were connected to the outer surfaces of the first terminal 109a and the second terminal 109b, respectively, in the same manner as in Example 1.

Next, the honeycomb structure portion with the electrode layers, terminals and current-carrying components was immersed in a bath of the same moisture absorbent slurry as in Example 1 for 3 minutes. Thereafter, the honeycomb structure portion with the electrode layers, terminals and current-carrying components was taken out of the bath, and the slurry on the outer peripheral surface of the honeycomb structure portion was removed by blowing and wiping. Next, by drying it in a dryer at 190° C. for 2 hours to form a first moisture absorbent-containing layer 107a, a second moisture absorbent-containing layer 107b, a third moisture absorbent-containing layer 111a, a fourth moisture absorbent-containing layer 111b, and a fifth moisture absorbent-containing layer, thereby obtaining a heater element.

The ratio (coverage rate) of the area that the first moisture layer 107b) covered the outer surface of the first electrode layer 102a (the second electrode layer 102b) to the area of the portion where the first terminal 109a (the second terminal 109b) was not connected among the outer surface of the first electrode layer 102a (the second electrode layer 102b) was calculated based on the both areas.

The ratio (coverage rate) of the area of the outer surface of the first terminal 109a (the second terminal 109b) covered by the third moisture absorbent-containing layer 111a (the fourth moisture absorbent-containing layer 111b) to the area of the portion where the current-carrying component 105a was not connected among the outer surface of the first terminal 109a (the second terminal 109b) was calculated based on the both areas.

The ratio (coverage rate) of the area covered by the fifth moisture absorbent-containing layer 113 to the area of the surface of the partition walls 106 forming the flow paths inside the cells 104 was calculated by the measurement procedure described above. Further, the average thickness of the first moisture absorbent-containing layer 107a (the second moisture absorbent-containing layer 107b), the average thickness of the third moisture absorbent-containing layer 111a (the fourth moisture absorbent-containing layer 111b), and the average thickness of the fifth moisture absorbent-containing layer 113 were measured using the measurement procedures described above.

The results are shown in Table 1.

According to the procedure described above, electrical resistance measurements were performed at 12 locations on each of the first moisture absorbent-containing layer 107a and the second moisture absorbent-containing layer 107b. The electrical resistance range (minimum value to maximum value) at this time is shown in Table 1.

According to the procedure described above, electrical resistance measurements were performed at 5 locations between two arbitrary points spaced 3 mm apart on the outer surfaces of the third moisture absorbent-containing layer 111a and the fourth moisture absorbent-containing layer 111b at 25° C. The range of electrical resistance (minimum value to maximum value) is shown in Table 1.

According to the procedure described above, electrical resistance measurements were performed at 5 locations between two arbitrary points spaced 3 mm apart on the fifth moisture absorbent-containing layer 113. The range of electrical resistance (minimum value to maximum value) is shown in Table 1.

### Example 4

A heater element was prepared in the same manner as in Example 1, except that the manufacturing conditions were changed as follows:
The ratio (coverage rate) of the area that the first moisture absorbent-containing layer 107a (the second moisture absorbent-containing layer 107b) covered the outer surface of the first electrode layer 102a (the second electrode layer 102b) to the area of the portion where the first terminal 109a (the second terminal 109b) was not connected among the outer surface of the first electrode layer 102a (the second electrode layer 102b) was changed to the values shown in Table 1 by changing the application area of the moisture absorbent slurry.

### Example 5

A heater element was prepared in the same manner as in Example 2, except that the manufacturing conditions were changed as follows:
The ratio (coverage rate) of the area that the first moisture absorbent-containing layer 107a (the second moisture absorbent-containing layer 107b) covered the outer surface of the first electrode layer 102a (the second electrode layer 102b) to the area of the portion where the first terminal 109a (the second terminal 109b) was not connected among the outer surface of the first electrode layer 102a (the second electrode layer 102b) was changed to the values shown in Table 1 by changing the application area of the moisture absorbent slurry.
The ratio (coverage rate) of the area of the outer surface of the first terminal 109a (the second terminal 109b) covered by the third moisture absorbent-containing layer 111a (the fourth moisture absorbent-containing layer 111b) to the area of the portion where the current-carrying component 105a was not connected among the outer surface of the first terminal 109a (the second terminal 109b) was changed to the values shown in Table 1 by changing the application area of the moisture absorbent slurry.

### Example 6

A heater element was prepared in the same manner as in Example 3, except that the manufacturing conditions were changed as follows:
The ratio (coverage rate) of the area that the first moisture absorbent-containing layer 107a (the second moisture absorbent-containing layer 107b) covered the outer surface of the first electrode layer 102a (the second electrode layer 102b) to the area of the portion where the first terminal 109a (the second terminal 109b) was not connected among the outer surface of the first electrode layer 102a (the second electrode layer 102b) was changed to the values shown in Table 1 by changing the application area of the moisture absorbent slurry.
The ratio (coverage rate) of the area of the outer surface of the first terminal 109a (the second terminal 109b) covered by the third moisture absorbent-containing layer 111a (the fourth moisture absorbent-containing layer 111b) to the area of the portion where the current-carrying component 105a was not connected among the outer surface of the first terminal 109a (the second terminal 109b) was changed to the values shown in Table 1 by changing the application area of the moisture absorbent slurry.
The ratio (coverage rate) of the area covered by the fifth moisture absorbent-containing layer 113 to the area of the surface of the partition walls 106 forming the flow paths inside the cells 104 was changed to the value shown in Table 1 by changing the method of immersing the honeycomb structure portion with the electrode layers, terminals and current-carrying components in the bath of the moisture absorbent slurry. Specifically, by performing a step of immersing the honeycomb structure portion with the electrode layers, terminals and current-carrying components in a bath of moisture absorbent slurry to a predetermined depth from the first end surface 101a side in the direction in which the cells extend, and a step of immersing the honeycomb structure part portion with the electrode layers, terminals and current-carrying components in a bath of moisture absorbent slurry to a predetermined depth from the second end surface 101b side in the direction in which the cells extend, a region where no moisture absorbent-containing layer was formed was provided on a part of the surface of the partition walls 106 forming the flow paths inside the cells 104. In addition, when the honeycomb structure portion was immersed in a bath of moisture absorbent slurry, the first end surface 101a and the second end surface 101b were masked to prevent the moisture absorbent slurry from adhering to the first end surface 101a and the second end surface 101b.

### Example 7

A heater element was prepared in the same manner as in Example 4, except that the manufacturing conditions were changed as follows:
The average thicknesses of the first moisture absorbent-containing layer and the second moisture absorbent-containing layer were changed to the values shown in Table 1 by adjusting the viscosity of the moisture-absorbent slurry.

### Example 8

A heater element was prepared in the same manner as in Example 5, except that the manufacturing conditions were changed as follows:
The average thicknesses of the first moisture absorbent-containing layer and the second moisture absorbent-containing layer were changed to the values shown in Table 1 by changing the viscosity of the moisture-absorbent slurry.
The average thicknesses of the third moisture absorbent-containing layer and the fourth moisture absorbent-containing layer were changed to the values shown in Table 1 by changing the viscosity of the moisture-absorbent slurry.

### Example 9

A heater element was prepared in the same manner as in Example 6, except that the manufacturing conditions were changed as follows:
The average thicknesses of the first moisture absorbent-containing layer and the second moisture absorbent-containing layer were changed to the values shown in Table 1 by changing the viscosity of the moisture-absorbent slurry.
The average thicknesses of the third moisture absorbent-containing layer and the fourth moisture absorbent-containing layer were changed to the values shown in Table 1 by changing the viscosity of the moisture-absorbent slurry.
The average thicknesses of the fifth moisture absorbent-containing layer was changed to the values shown in Table 1 by changing the viscosity of the moisture-absorbent slurry.

### Comparative Example 1

A heater element was prepared in the same manner as in Example 1, except that the manufacturing conditions were changed as follows:
Neither the first moisture absorbent-containing layer nor the second moisture absorbent-containing layer was formed.

### Comparative Example 2

A heater element was prepared in the same manner as in Example 6, except that the manufacturing conditions were changed as follows:
The honeycomb structure portion was taken out of the bath of the moisture absorbent slurry, and the slurry on both end surfaces and the outer peripheral face was removed by blowing and wiping, and then the slurry was dried.

### Comparative Example 3

A pair of electrode layers (first electrode layer 102a and second electrode layer 102b) were bonded to both end surfaces of the honeycomb structure portion using the same method as in Example 1.

Next, the first terminal 109a and the second terminal 109b were connected to the outer surfaces of the first electrode layer 102a and the second electrode layer 102b, respectively, in the same manner as in Example 1. Next, the electric wires which are the current-carrying components 105a, 105b were connected to the outer surfaces of the first terminal 109a and the second terminal 109b, respectively, in the same manner as in Example 1.

Next, polyamide powder resin having a particle size of about 100 μm was introduced into a thermal spray gun and applied to the outer surface of the first electrode layer 102a and the outer surface of the second electrode layer 102b by thermal spraying using the heat of propane-oxygen combustion, thereby preparing a heater element. In this heater element, the outer surface of a first electrode layer 102a was coated with a first resin-containing layer, and the outer surface of a second electrode layer 102b was coated with a second resin-containing layer.

The ratio (coverage rate) of the area of the outer surface of the first electrode layer 102a (the second electrode layer 102b) covered by the first resin-containing layer (the second resin-containing layer) to the area of the portion where the first terminal 109a (the second terminal 109b) is not connected among the outer surface of the first electrode layer 102a (the second electrode layer 102b) was calculated based on the both areas. The results are shown in Table 1. In addition, the average thickness of the first resin-containing layer (the second resin-containing layer) was measured by the same method as that for the first moisture absorbent-containing layer 107a (the second moisture absorbent-containing layer 107b). The results are shown in Table 1.

For the first resin-containing layer and the second resin-containing layer, electrical resistance measurements were performed at 12 locations, respectively, in the same manner as that of the first moisture absorbent-containing layer 107a and the second moisture absorbent-containing layer 107b. The range of electrical resistance (minimum value to maximum value) is shown in Table 1.

### Comparative Example 4

A pair of electrode layers (the first electrode layer 102a and the second electrode layer 102b) were bonded to both end surfaces of the honeycomb structure portion using the same method as in Example 1.

Next, the first terminal 109a and the second terminal 109b were connected to the outer surfaces of the first electrode layer 102a and the second electrode layer 102b, respectively, in the same manner as in Example 1. Next, the electric wires which are the current-carrying components 105a, 105b were connected to the outer surfaces of the first terminal 109a and the second terminal 109b, respectively, in the same manner as in Example 1.

Next, a polyamide powder resin having a particle size of about 100 μm and a solvent (ethyl alcohol) were mixed in a mass ratio of polyamide powder resin:solvent=1:1, and stirred to prepare a resin slurry. The honeycomb structure portion with the electrode layers, terminals and current-carrying components was immersed in the resin slurry bath for 10 seconds. After that, the honeycomb structure portion with the electrode layers, terminals and current-carrying components was taken out of the bath, and the slurry on the outer peripheral surface of the honeycomb structure portion was removed by blowing and wiping. Next, it was dried in a dryer at 80° C. for 0.5 hour, and then heat-treated at 250° C. to prepare a heater element. In this heater element, the outer surface of a first electrode layer 102a was coated with a first resin-containing layer, and the outer surface of a second electrode layer 102b was coated with a second resin-containing layer. In addition, the outer surface of first terminal 109a was coated with a third resin-containing layer, the outer surface of second terminal 109b was coated with a fourth resin-containing layer. In addition, the surface of partition walls 106 forming the flow paths inside the cells 104 was coated with a fifth resin-containing layer.

The ratio (coverage rate) of the area of the outer surface of the first electrode layer 102a (the second electrode layer 102b) covered by the first resin-containing layer (the second resin-containing layer) to the area of the portion where the first terminal 109a (the second terminal 109b) was not connected among the outer surface of the first electrode layer 102a (second electrode layer 102b), was calculated based on the both areas.

The ratio (coverage rate) of the area of the outer surface of the first terminal 109a (the second terminal 109b) covered by the third resin-containing layer (the fourth resin-containing layer) to the area of the portion where the current-carrying component 105a was not connected among the outer surface of the first terminal 109a (the second terminal 109b) was calculated based on the both areas.

The ratio (coverage) of the area covered by the fifth resin-containing layer to the area of the surface of the partition walls 106 forming the flow paths inside the cells 104 was calculated by the same measurement procedure as for the fifth moisture absorbent-containing layer.

Further, the average thickness of the first resin-containing layer (the second resin-containing layer), the average thickness of the third resin-containing layer (the fourth resin-containing layer), and the average thickness of the fifth resin-containing layer were measured using the measurement procedures described above.

The results are shown in Table 1.

For the first resin-containing layer and the second resin-containing layer, electrical resistance measurements were performed at 12 locations in the same manner as that for the first moisture absorbent-containing layer 107a and the second moisture absorbent-containing layer 107b. The range of electrical resistance (minimum value to maximum value) is shown in Table 1.

For the electrical resistance of the third resin-containing layer and the fourth resin-containing layer, electrical resistance measurements were performed at 12 locations, respectively, in the same manner as that for the third moisture absorbent-containing layer 111a and the fourth moisture absorbent-containing layer 111b. The range of electrical resistance (minimum value to maximum value) is shown in Table 1.

The electrical resistance was measured at 12 locations on the fifth resin-containing layer in the same manner as that for the fifth moisture absorbent-containing layer 113. The range of electrical resistance (minimum value to maximum value) is shown in Table 1.

In addition, the polyamide resins used in Comparative Examples 3 and 4 were examined for their moisture absorption properties. After drying at 180° C. for 2 hours or more, 5 g of the polyamide resin was left to stand for one hour in a thermo-hygrostat kept at room temperature (25° C.) and a relative humidity of 50%. The mass of water that could be absorbed per gram of dry mass was calculated from the increased mass of the polyamide resin removed from the thermo-hygrostat, but the amount of water absorbed was not enough to meet the definition of a moisture absorbent. The results are shown in Table 1.

### [4. Evaluation of Heater Element]

The heater elements according to the Examples and Comparative Examples obtained by the above-mentioned manufacturing methods were evaluated for their moisture absorption characteristics, condensation water generation status, and short circuit prevention effect. In addition, a necessary number of the heater elements according to the Examples and Comparative Examples were prepared for the evaluation.

### <Moisture Absorption Characteristics>

Using the measurement procedure described above, the maximum water absorption of the entire heater element, as well as the maximum water absorption of the first and second regions of the heater element, were measured. The results are shown in Table 1.

### <Condensation Generation>

The heater element was cooled to −10° C. After that, air with a temperature of 80° C. and a relative humidity of 90% was passed through each cell of the heater element for 5 minutes at a flow rate of 2 m/sec. At this time, the amount of droplets detected downstream of the heater element was measured using a droplet detection sheet manufactured by Nippon Paper Industries Co., Ltd., using a discoloration score coefficient method. Evaluation was performed according to the following criteria. The results are shown in Table 1.
Not detected: Discoloration score is less than 3
Trace amount: Discoloration score is 3 or more to less than 10
Large amount: Discoloration score is 10 or more

### <Short Circuit Prevention Performance>

The heater element was placed in an environment of 90° C. and 90% relative humidity. Every 100 hours, a voltage of 12V was applied to the pair of electrode layers via an electric wire to measure the electrical resistance of the heater element. The time elapsed until the electrical resistance increased by 10% or more from the initial value was investigated. Evaluation was performed according to the following criteria. The results are shown in Table 1.
Circle: 800 hours or more
Triangle: 500 hours or more but less than 800 hours
x: Less than 500 hours

TABLE 1

| | | Unit | Example 1 | Example 2 | Example 3 | Example 4 | Example 5 | Example 6 |
|---|---|---|---|---|---|---|---|---|
| First and | Component | | Pure | Pure | Pure | Pure | Pure | Pure |
| second | | | Aluminum | Aluminum | Aluminum | Aluminum | Aluminum | Aluminum |
| electrode | Coverage rate to area of | % | [symbol] | [symbol] | [symbol] | [symbol] | [symbol] | [symbol] |
| layers | first end surface | | | | | | | |
| | excluding cell openings | | | | | | | |
| | Coverage rate to area of | % | [symbol] | [symbol] | [symbol] | [symbol] | [symbol] | [symbol] |
| | second end surface | | | | | | | |
| | excluding cell openings | | | | | | | |
| | Average thickness of | μm | 100 | 100 | 100 | 100 | 100 | 100 |
| | first electrode layer | | | | | | | |
| | Average thickness of | μm | 100 | 300 | 100 | 100 | 100 | 100 |
| | second electrode layer | | | | | | | |
| | Volume resistivity at 25° C. | Ωcm | 2.0 × 10⁻⁷ | 2.0 × 10⁻⁷ | 2.0 × 10⁻⁷ | 2.0 × 10⁻⁷ | 2.0 × 10⁻⁷ | 2.0 × 10⁻⁷ |
| First and | Component | % by | Amorphous | Amorphous | Amorphous | Amorphous | Amorphous | Amorphous |
| second | | mass | alumino- | alumino- | alumino- | alumino- | alumino- | alumino- |
| moisture | | | silicate 95%, | silicate 95%, | silicate 95%, | silicate 95%, | silicate 95%, | silicate 95%, |
| absorbent- | | | silica 5% | silica 5% | silica 5% | silica 5% | silica 5% | silica 5% |
| containing | Moisture absorption | g/g | 15 | 15 | 15 | 15 | 15 | 15 |
| layers | performance | | | | | | | |
| (First and | (25° C., RH50%, 1 hr) | | | | | | | |
| second resin- | Moisture adsorption | ° C. | 50 | 50 | 50 | 50 | 50 | 50 |
| containing | temperature | | | | | | | |
| layers in | Moisture desorption | ° C. | 70 | 70 | 70 | 70 | 70 | 70 |
| Comparative | temperature | | | | | | | |
| Examples | Coverage rate to area of portion | % | 99 | 99 | 99 | 80 | 80 | 80 |
| 3 and 4) | where first terminal is not | | | | | | | |
| | connected among outer surface | | | | | | | |
| | of first electrode layer | | | | | | | |
| | Coverage rate to area of portion | % | 99 | 99 | 99 | 80 | 80 | 80 |
| | where second terminal is not | | | | | | | |
| | connected among outer surface | | | | | | | |
| | of second electrode layer | | | | | | | |
| | Range of electrical resistance of | Ω | 5.0 × 10 [symbol] | 5.0 × 10 [symbol] | 5.0 × 10 [symbol] | 5.0 × 10 [symbol] | 5.0 × 10 [symbol] | 5.0 × 10 [symbol] |
| | first moisture absorbent- | | to | to | to | to | to | to |
| | containing layer at 25° C. | | 1.0 × 10 [symbol] | 1.0 × 10 [symbol] | 1.0 × 10 [symbol] | 1.0 × 10 [symbol] | 1.0 × 10 [symbol] | 1.0 × 10 [symbol] |
| | Range of electrical resistance of | Ω | 5.0 × 10 [symbol] | 5.0 × 10 [symbol] | 5.0 × 10 [symbol] | 5.0 × 10 [symbol] | 5.0 × 10 [symbol] | 5.0 × 10 [symbol] |
| | second moisture absorbent- | | to | to | to | to | to | to |
| | containing layer at 25° C. | | 1.0 × 10 [symbol] | 1.0 × 10 [symbol] | 1.0 × 10 [symbol] | 1.0 × 10 [symbol] | 1.0 × 10 [symbol] | 1.0 × 10 [symbol] |
| | Average thickness of first | μm | 100 | 100 | 100 | 100 | 100 | 100 |
| | moisture absorbent-containig | | | | | | | |
| | layer | | | | | | | |
| | Average thickness of second | μm | 100 | 100 | 100 | 100 | 100 | 100 |
| | moisture absorbent containing | | | | | | | |
| | layer | | | | | | | |
| First and | Component | | Pure | Pure | Pure | Pure | Pure | Pure |
| second | | | Aluminum | Aluminum | Aluminum | Aluminum | Aluminum | Aluminum |
| terminals | Planar dimension | mm | 5 mm × | 5 mm × | 5 mm × | 5 mm × | 5 mm × | 5 mm × |
| | | | 30 mm | 30 mm | 30 mm | 30 mm | 30 mm | 30 mm |
| | Thickness | mm | 1 | 1 | 1 | 1 | 1 | 1 |
| | Coverage rate to area of | % | 2 | 2 | 2 | 2 | 2 | 2 |
| | first end surface | | | | | | | |
| | Coverage rate to area of | % | 2 | 2 | 2 | 2 | 2 | 2 |
| | second end surface | | | | | | | |
| | Volume resistivity at 25° C. | Ωcm | 2.0 × 10⁻⁷ | 2.0 × 10⁻⁷ | 2.0 × 10⁻⁷ | 2.0 × 10⁻⁷ | 2.0 × 10⁻⁷ | 2.0 × 10⁻⁷ |
| Third and | Component | % by | | Amorphous | Amorphous | | Amorphous | Amorphous |
| fourth | | mass | | alumino- | alumino- | | alumino- | alumino- |
| moisture | | | | silicate 95%, | silicate 95%, | | silicate 95%, | silicate 95%, |
| absorbent- | | | | silica 5% | silica 5% | | silica 5% | silica 5% |
| containing | Moisture absorption | g/g | | 15 | 15 | | 15 | 15 |
| layers | performance (25° C. RH50%, 1 hr) | | | | | | | |
| (Third and | Moisture adsorption temperature | ° C. | | 50 | 50 | | 50 | 50 |
| fourth resin- | Moisture desorption temperature | ° C. | | 70 | 70 | | 70 | 70 |
| containing | Coverage rate of area of outer | % | | 99 | 99 | | 90 | 90 |
| layers in | surface of first terminal where no | | | | | | | |
| Comparative | current-carrying component is | | | | | | | |
| Example 4) | connected | | | | | | | |
| | Coverage rate of area of outer | % | | 99 | 99 | | 90 | 90 |
| | surface of second terminal where | | | | | | | |
| | no current-carrying component is | | | | | | | |
| | connected | | | | | | | |
| | Range of electrical resistance of | Ω | | 5.0 × 10 [symbol] | 5.0 × 10 [symbol] | | 5.0 × 10 [symbol] | 5.0 × 10 [symbol] |
| | third moisture absorbent- | | | to | to | | to | to |
| | containing layer at 25° C. | | | 1.0 × 10 [symbol] | 1.0 × 10 [symbol] | | 1.0 × 10 [symbol] | 1.0 × 10 [symbol] |
| | Range of electrical resistance of | Ω | | 5.0 × 10 [symbol] | 5.0 × 10 [symbol] | | 5.0 × 10 [symbol] | 5.0 × 10 [symbol] |
| | fourth moisture absorbent- | | | to | to | | to | to |
| | containing layer at 25° C. | | | 1.0 × 10 [symbol] | 1.0 × 10 [symbol] | | 1.0 × 10 [symbol] | 1.0 × 10 [symbol] |
| | Average thickness of third | μm | | 100 | 100 | | 100 | 100 |
| | moisture absorbent-containing | | | | | | | |
| | layer | | | | | | | |
| | Average thickness of fourth | μm | | 100 | 100 | | 100 | 100 |
| | moisture absorbent-containing | | | | | | | |
| | layer | | | | | | | |
| Fifth | Component | % by | | | Amorphous | | | Amorphous |
| moisture | | mass | | | alumino- | | | alumino- |
| absorbent- | | | | | silicate 95%, | | | silicate 95%, |
| containing | | | | | silica 5% | | | silica 5% |
| layer | Moisture absorption | g/g | | | 15 | | | 15 |
| (Fifth resin- | performance | | | | | | | |
| containing | (25° C., RH50%, 1 hr) | | | | | | | |
| layer in | Moisture adsorption | ° C. | | | 50 | | | 50 |
| Comparative | temperature | | | | | | | |
| Example 4) | Moisture desorption | ° C. | | | 70 | | | 70 |
| | temperature | | | | | | | |
| | Coverage rate to surface area | % | | | 99 | | | 80 |
| | of partition walls that form flow | | | | | | | |
| | paths inside cells | | | | | | | |
| | Range of electrical resistance | Ω | | | 2.0 × 10 [symbol] | | | 2.0 × 10 [symbol] |
| | at 25° C. | | | | to | | | to |
| | | | | | 1.0 × 10 [symbol] | | | 1.0 × 10 [symbol] |
| | Average thickness | μm | | | 250 | | | 250 |
| Moisture | Maximum water absorption of | g/L | 20 | 50 | 200 | 180 | 150 | 180 |
| absorption | moisture absorbent per unit | | | | | | | |
| charac- | volume of honeycomb structure | | | | | | | |
| teristics | portion | | | | | | | |
| of heater | Maximum water absorption per | g/L | 200 | 200 | 220 | 180 | 180 | 180 |
| element | unit volume of first region | | | | | | | |
| | Maximum water absorption per | g/L | 200 | 200 | 220 | 180 | 180 | 180 |
| | unit volume of second region | | | | | | | |
| Conden- | Amount of droplets detected | Down- | Trace | Not | Not | Trace | Not | Not |
| sation | downstream (with the initial | stream | amount | detected | detected | amount | detected | detected |
| water | honeycomb temperature portion | water | | | | | | |
| generation | at −10° C. air with a | droplet | | | | | | |
| | temperature of 80° C. and a | detection | | | | | | |
| | relative humidity of 90% is | discol- | | | | | | |
| | allowed to flow for 5 minutes at | oration | | | | | | |
| | a flow rate of 2 m/sec.) | score | | | | | | |
| Short circuit | Resistance change after | | Δ | ∘ | ∘ | Δ | ∘ | ∘ |
| prevention | durability test | | | | | | | |
| effect | | | | | | | | |
| Remarks | | | First and | Example 1 + | Example 2 + | Example of | Example of | Example of |
| | | | second | third and | fifth | changed | changed | changed |
| | | | moisture | fourth | moisture | coverage | coverage | coverage |
| | | | absorbent- | moisture | absorbent- | rate | rate | rate |
| | | | containing | absorbent- | containing | | | |
| | | | layers only | containing | layer | | | |
| | | | | Layers | | | | |

| | | | | | Compararive | Compararive | Compararive | Compararive |
|---|---|---|---|---|---|---|---|---|
| | | Example 7 | Example 8 | Example 9 | Example 1 | Example 2 | Example 3 | Example 4 |
| First and | Component | Pure | Pure | Pure | Pure | Pure | Pure | Pure |
| second | | Aluminum | Aluminum | Aluminum | Aluminum | Aluminum | Aluminum | Aluminum |
| electrode | Coverage rate to area of | [symbol] | [symbol] | [symbol] | [symbol] | [symbol] | [symbol] | [symbol] |
| layers | first end surface | | | | | | | |
| | excluding cell openings | | | | | | | |
| | Coverage rate to area of | [symbol] | [symbol] | [symbol] | [symbol] | [symbol] | [symbol] | [symbol] |
| | second end surface | | | | | | | |
| | excluding cell openings | | | | | | | |
| | Average thickness of | 100 | 100 | 100 | 100 | 100 | 100 | 100 |
| | first electrode layer | | | | | | | |
| | Average thickness of | 100 | 100 | 100 | 100 | 100 | 100 | 100 |
| | second electrode layer | | | | | | | |
| | Volume resistivity at 25° C. | 2.0 × 10⁻⁷ | 2.0 × 10⁻⁷ | 2.0 × 10⁻⁷ | 2.0 × 10⁻⁷ | 2.0 × 10⁻⁷ | 2.0 × 10⁻⁷ | 2.0 × 10⁻⁷ |
| First and | Component | Amorphous | Amorphous | Amorphous | | | Polyamide | Polyamide |
| second | | alumino- | alumino- | alumino- | | | resin (not | resin (not |
| moisture | | silicate 95%, | silicate 95%, | silicate 95%, | | | moisture | moisture |
| absorbent- | | silica 5% | silica 5% | silica 5% | | | absorbing) | absorbing) |
| containing | Moisture absorption | 15 | 15 | 15 | | | 0 | 0 |
| layers | performance | | | | | | | |
| (First and | (25° C., RH50%, 1 hr) | | | | | | | |
| second resin- | Moisture adsorption | 50 | 50 | 50 | | | — | — |
| containing | temperature | | | | | | | |
| layers in | Moisture desorption | 70 | 70 | 70 | | | — | — |
| Comparative | temperature | | | | | | | |
| Examples | Coverage rate to area of portion | 80 | 80 | 80 | | | 99 | 99 |
| 3 and 4) | where first terminal is not | | | | | | | |
| | connected among outer surface | | | | | | | |
| | of first electrode layer | | | | | | | |
| | Coverage rate to area of portion | 80 | 80 | 80 | | | 99 | 99 |
| | where second terminal is not | | | | | | | |
| | connected among outer surface | | | | | | | |
| | of second electrode layer | | | | | | | |
| | Range of electrical resistance of | 5.0 × 10 [symbol] | 5.0 × 10 [symbol] | 5.0 × 10 [symbol] | | | 1.0 × 10 [symbol] | 1.0 × 10 [symbol] |
| | first moisture absorbent- | to | to | to | | | to | to |
| | containing layer at 25° C. | 1.0 × 10 [symbol] | 1.0 × 10 [symbol] | 1.0 × 10 [symbol] | | | 1.0 × 10 [symbol] | 1.0 × 10 [symbol] |
| | Range of electrical resistance of | 5.0 × 10 [symbol] | 5.0 × 10 [symbol] | 5.0 × 10 [symbol] | | | 1.0 × 10 [symbol] | 1.0 × 10 [symbol] |
| | second moisture absorbent- | to | to | to | | | to | to |
| | containing layer at 25° C. | 1.0 × 10 [symbol] | 1.0 × 10 [symbol] | 1.0 × 10 [symbol] | | | 1.0 × 10 [symbol] | 1.0 × 10 [symbol] |
| | Average thickness of first | 50 | 50 | 50 | | | 50 | 50 |
| | moisture absorbent-containig | | | | | | | |
| | layer | | | | | | | |
| | Average thickness of second | 50 | 50 | 50 | | | 50 | 50 |
| | moisture absorbent containing | | | | | | | |
| | layer | | | | | | | |
| First and | Component | Pure | Pure | Pure | Pure | Pure | Pure | Pure |
| second | | Aluminum | Aluminum | Aluminum | Aluminum | Aluminum | Aluminum | Aluminum |
| terminals | Planar dimension | 5 mm × | 5 mm × | 5 mm × | 5 mm × | 5 mm × | 5 mm × | 5 mm × |
| | | 30 mm | 30 mm | 30 mm | 30 mm | 30 mm | 30 mm | 30 mm |
| | Thickness | 1 | 1 | 1 | 1 | 1 | 1 | 1 |
| | Coverage rate to area of | 2 | 2 | 2 | 2 | 2 | 2 | 2 |
| | first end surface | | | | | | | |
| | Coverage rate to area of | 2 | 2 | 2 | 2 | 2 | 2 | 2 |
| | second end surface | | | | | | | |
| | Volume resistivity at 25° C. | 2.0 × 10⁻⁷ | 2.0 × 10⁻⁷ | 2.0 × 10⁻⁷ | 2.0 × 10⁻⁷ | 2.0 × 10⁻⁷ | 2.0 × 10⁻⁷ | 2.0 × 10⁻⁷ |
| Third and | Component | | Amorphous | Amorphous | | | | Polyamide |
| fourth | | | alumino- | alumino- | | | | resin (not |
| moisture | | | silicate 95%, | silicate 95%, | | | | moisture |
| absorbent- | | | silica 5% | silica 5% | | | | absorbing) |
| containing | Moisture absorption | | 15 | 15 | | | | 0 |
| layers | performance (25° C. RH50%, 1 hr) | | | | | | | |
| (Third and | Moisture adsorption temperature | | 50 | 50 | | | | — |
| fourth resin- | Moisture desorption temperature | | 70 | 70 | | | | — |
| containing | Coverage rate of area of outer | | 90 | 90 | | | | 99 |
| layers in | surface of first terminal where no | | | | | | | |
| Comparative | current-carrying component is | | | | | | | |
| Example 4) | connected | | | | | | | |
| | Coverage rate of area of outer | | 90 | 90 | | | | 99 |
| | surface of second terminal where | | | | | | | |
| | no current-carrying component is | | | | | | | |
| | connected | | | | | | | |
| | Range of electrical resistance of | | 5.0 × 10 [symbol] | 5.0 × 10 [symbol] | | | | 1.0 × 10 [symbol] |
| | third moisture absorbent- | | to | to | | | | to |
| | containing layer at 25° C. | | 1.0 × 10 [symbol] | 1.0 × 10 [symbol] | | | | 1.0 × 10 [symbol] |
| | Range of electrical resistance of | | 5.0 × 10 [symbol] | 5.0 × 10 [symbol] | | | | 1.0 × 10 [symbol] |
| | fourth moisture absorbent- | | to | to | | | | to |
| | containing layer at 25° C. | | 1.0 × 10 [symbol] | 1.0 × 10 [symbol] | | | | 1.0 × 10 [symbol] |
| | Average thickness of third | | 50 | 50 | | | | 150 |
| | moisture absorbent-containing | | | | | | | |
| | layer | | | | | | | |
| | Average thickness of fourth | | 50 | 50 | | | | 150 |
| | moisture absorbent-containing | | | | | | | |
| | layer | | | | | | | |
| Fifth | Component | | | Amorphous | | Amorphous | | Polyamide |
| moisture | | | | alumino- | | alumino- | | resin (not |
| absorbent- | | | | silicate 95%, | | silicate 95%, | | moisture |
| containing | | | | silica 5% | | silica 5% | | absorbing) |
| layer | Moisture absorption | | | 15 | | 15 | | — |
| (Fifth resin- | performance | | | | | | | |
| containing | (25° C., RH50%, 1 hr) | | | | | | | |
| layer in | Moisture adsorption | | | 50 | | 50 | | — |
| Comparative | temperature | | | | | | | |
| Example 4) | Moisture desorption | | | 70 | | 70 | | — |
| | temperature | | | | | | | |
| | Coverage rate to surface area | | | 80 | | 80 | | 99 |
| | of partition walls that form flow | | | | | | | |
| | paths inside cells | | | | | | | |
| | Range of electrical resistance | | | 2.0 × 10 [symbol] | | 2.0 × 10 [symbol] | | 1.0 × 10 [symbol] |
| | at 25° C. | | | to | | to | | to |
| | | | | 1.0 × 10 [symbol] | | 1.0 × 10 [symbol] | | 1.0 × 10 [symbol] |
| | Average thickness | | | 100 | | 250 | | 250 |
| Moisture | Maximum water absorption of | 85 | 85 | 85 | 0 | 180 | 0 | 0 |
| absorption | moisture absorbent per unit | | | | | | | |
| charac- | volume of honeycomb structure | | | | | | | |
| teristics | portion | | | | | | | |
| of heater | Maximum water absorption per | 90 | 90 | 90 | 0 | 137 | 0 | 0 |
| element | unit volume of first region | | | | | | | |
| | Maximum water absorption per | 90 | 90 | 90 | 0 | 137 | 0 | 0 |
| | unit volume of second region | | | | | | | |
| Conden- | Amount of droplets detected | Trace | Not | Not | Large | Not | Large | Large |
| sation | downstream (with the initial | amount | detected | detected | amount | detected | amount | amount |
| water | honeycomb temperature portion | | | | | | | |
| generation | at −10° C. air with a | | | | | | | |
| | temperature of 80° C. and a | | | | | | | |
| | relative humidity of 90% is | | | | | | | |
| | allowed to flow for 5 minutes at | | | | | | | |
| | a flow rate of 2 m/sec.) | | | | | | | |
| Short circuit | Resistance change after | Δ | ∘ | ∘ | x | x | x | ∘ |
| prevention | durability test | | | | | | | |
| effect | | | | | | | | |
| Remarks | | Example of | Example of | Example of | Untreated | Fifth | End | End |
| | | changed | changed | changed | honeycomb | moisture | surfaces are | surfaces and |
| | | thickness | thickness | thickness | structure | absorbent- | covered with | inside of |
| | | and | and | and | portion | containing | insulating | cells are |
| | | coverage | coverage | coverage | | layer is | resin, but | covered with |
| | | rate | rate | rate | | present but | it is not | insulating |
| | | | | | | no first, | moisture | resin, but |
| | | | | | | second, | absorbing. | it is not |
| | | | | | | third or | | moisture |
| | | | | | | fourth | | absorbing. |
| | | | | | | moisutre | | |
| | | | | | | absorbent- | | |
| | | | | | | containing | | |
| | | | | | | layers are | | |
| | | | | | | present | | |

[symbol]

indicates data missing or illegible when filed

### DESCRIPTION OF REFERENCE NUMERALS

1100: Heater element
101a: First end surface
101b: Second end surface
102a: First electrode layer
102b: Second electrode layer
103: Outer peripheral wall
103e: Outer peripheral surface
104: Cell
105a: Current-carrying component
105b: Current-carrying component
106: Partition wall
107a: First moisture absorbent-containing layer
107b: Second moisture absorbent-containing layer
109a: First terminal
109b: Second terminal
111a: Third moisture absorbent-containing layer
111b: Fourth moisture absorbent-containing layer
113: Fifth moisture absorbent-containing layer
120: Frame
121: First frame
121a: Holding portion
121b: Flange portion
122: Second frame
122a: Holding portion
122b: Flange portion
124: Fastener
125: Concave portion
126a: Portion protruding locally toward the inner circumference
126b: Portion protruding locally toward the inner circumference
127: Cushioning material
129: Cushioning material
140: Frame
140a: Member
140b: Member
141: First frame portion
141i: Inner peripheral surface
142: Second frame portion
143: Third frame portion
144: Connecting portion
144a: Convex portion
144b: Concave portion
145: Cushioning material
150: Cushioning material
200: Power source
300: Switching valve
310: Rotating shaft
312: Opening/closing door
314: Actuator
400: Inflow pipe
500: Outflow pipe
500a: First route
500b: Second route
600: Ventilator
810: Electric wire
820: Electric wire
830: Electric wire
900: Controller
910: Power switch
1000: First air conditioning system

1. A heater element, comprising:
a honeycomb structure portion capable of generating heat by energization, comprising an outer peripheral wall, and partition walls disposed on an inner peripheral side of the outer peripheral wall, the partition walls partitioning a plurality of cells that form flow paths extending from a first end surface to a second end surface, and the partition walls comprising a material having a PTC characteristic;
a first electrode layer covering a part or all of a surface of the partition walls forming the first end surface;
a second electrode layer covering a part or all of a surface of the partition walls forming the second end surface;
a first moisture absorbent-containing layer covering a part of an outer surface of the first electrode layer; and
a second moisture absorbent-containing layer covering a part of an outer surface of the second electrode layer.

2. The heater element according to claim 1, wherein an average thickness of at least one of the first moisture absorbent-containing layer and the second moisture absorbent-containing layer is 10 μm or more and 500 μm or less.

3. The heater element according to claim 1, wherein a maximum water absorption (g) of the heater element per unit volume (1 liter) of the honeycomb structure portion is 20 to 400 g/liter.

4. The heater element according to claim 1, wherein the first moisture absorbent-containing layer and the second moisture absorbent-containing layer are insulating.

5. The heater element according to claim 1, wherein the first moisture absorbent-containing layer and the second moisture absorbent-containing layer comprise an inorganic binder.

6. The heater element according to claim 1, wherein the first moisture absorbent-containing layer and the second moisture absorbent-containing layer comprise, in addition to the moisture absorbent, a functional material having a function of adsorbing carbon dioxide and/or an organic gas component.

7. The heater element according to claim 1,
wherein assuming a region having a length of 0.5 cm from the outer surface of the first moisture absorbent-containing layer toward the second end surface in a direction in which the cells extend is a first region, a maximum water absorption amount per unit volume (1 liter) of the first region is 90 to 200 g/liter; and
wherein assuming a region having a length of 0.5 cm from the outer surface of the second moisture absorbent-containing layer toward the first end surface in a direction in which the cells extend is a second region, a maximum water absorption amount per unit volume (1 liter) of the second region is 90 to 200 g/liter.

8. The heater element according to claim 1, wherein an average thickness of the first electrode layer and the average thickness of the second electrode layer are 5 μm or more and 100 μm or less, respectively.

9. The heater element according to claim 1,
wherein the first moisture absorbent-containing layer covers 80% or more of an area among a portion of the outer surface of the first electrode layer to which a first terminal is not connected; and
wherein the second moisture absorbent-containing layer covers 80% or more of an area among a portion of the outer surface of the second electrode layer to which a second terminal is not connected.

10. The heater element according to claim 1, further comprising:
a first terminal connected to a portion of the outer surface of the first electrode layer that is not covered by the first moisture absorbent-containing layer;
a second terminal connected to a portion of the outer surface of the second electrode layer that is not covered by the second moisture absorbent-containing layer;
a third moisture absorbent-containing layer that covers a portion of an outer surface of the first terminal; and
a fourth moisture absorbent-containing layer that covers a portion of an outer surface of the second terminal.

11. The heating element according to claim 10, wherein the third moisture absorbent-containing layer and the fourth moisture absorbent-containing layer are insulating.

12. The heater element according to claim 10, wherein the third moisture absorbent-containing layer and the fourth moisture absorbent-containing layer comprise an inorganic binder.

13. The heater element according to claim 10, wherein the third moisture absorbent-containing layer and the fourth moisture absorbent-containing layer comprise, in addition to the moisture absorbent, a functional material having a function of adsorbing carbon dioxide and/or an organic gas component.

14. The heater element according to claim 1, wherein the first electrode layer and the second electrode layer comprise one or more selected from a group consisting of pure aluminum, an aluminum alloy, and stainless steel.

15. The heater element according to claim 14, wherein the first electrode layer and the second electrode layer have a single layer of pure aluminum, a two-layer structure of an Al—Ni alloy layer and a pure silver layer, or a two-layer structure of an Al—Ni alloy layer and a pure aluminum layer.

16. The heater element according to claim 10, wherein
the first terminal and the second terminal comprise one or more selected from pure aluminum, an aluminum alloy, and stainless steel;
the first terminal is connected to the portion of the outer surface of the first electrode layer that is not covered by the first moisture absorbent-containing layer by welding, brazing, or mechanical contact; and
the second terminal is connected to the portion of the outer surface of the second electrode layer that is not covered by the second moisture absorbent-containing layer by welding, brazing, or mechanical contact.

17. The heater element according to claim 1, further comprising a fifth moisture absorbent-containing layer covering a part or all of a surface of the partition walls forming the flow paths inside the cells.
